(19) United States
(12) Patent Application Publication
(10) Pub. No.: US 2016/0152114 A1
(43) Pub. Date: Jun. 2, 2016

(54) AIR EXHAUST VALVE AND MOTOR VEHICLE PROVIDED WITH AIR EXHAUST VALVE

(71) Applicant: HOWA TEXTILE INDUSTRY CO., LTD., Kasugai-shi, Aichi (JP)

(72) Inventor: Hiroshi YAMAMOTO, Kasugai-shi (JP)

(21) Appl. No.: 14/785,799

(22) PCT Filed: Apr. 16, 2014
(86) PCT No.: PCT/JP2014/060785

§ 371 Date: Oct. 20, 2015

(30) Foreign Application Priority Data
Apr. 26, 2013 (JP) 2013-093261

(51) Int. Cl. B60H 1/24; F16K 15/16

(52) U.S. Cl. CPC B60H 1/249; F16K 15/16

(57) ABSTRACT

In an air exhaust valve, a valve seat member has an annular valve seat portion at a valve seat portion wall thereof. A plate-shaped valve element is disposed on the rear side of the valve seat member so as to open and close the annular valve seat portion. A cover member is made of a sound absorption material, and bulges from the valve seat member to the front side at a sound absorption cover. An opening portion is formed in a lower wall of the sound absorption cover.

### BACKGROUND OF THE INVENTION

1. Field of the Invention

The present invention relates to an air exhaust valve and a motor vehicle provided with the air exhaust valve.

2. Description of the Related Art

With regard to an air exhaust valve of this type, heretofore, JP 2005-199856 A has proposed an air outlet for motor vehicles. The air outlet has an air outlet body and a flap. The air outlet body is mounted on a vehicle body. The flap is turnably fixed at one end thereof to a flap mounting portion of the air outlet body, and can be opened to and closed from the outside of the air outlet body.

In the air outlet for a motor vehicle, the flap closes and covers a ventilation hole in the air outlet body, and shields air from the outside of the vehicle body. The flap receives the pressure of air inside the vehicle body, which is caused, for instance, at closing the door, is opened to the outside of the vehicle body, and exhausts the air inside the vehicle body through the ventilation hole in the air outlet body, thereby enabling the door to be closed smoothly.

However, in the air outlet having the above construction, the flap is merely made of a thermoplastic resin, e.g., polypropylene, and lacks sound absorption ability. For this reason, In exhausting the air inside the vehicle body, the flap does not favorably absorb noises from the outside of the motor vehicle. Thus, the noises enter into the vehicle body, in particular, into the vehicle compartment through the ventilation hole in the air outlet body.

Consequently, the air outlet having the above construction can exhaust the air inside the vehicle body, but cannot favorably attenuate the noises from the outside of the motor vehicle. Each time a passenger in the vehicle compartment closes the door, he is bothered with the noises from the outside of the motor vehicle and has an uncomfortable feeling.

### SUMMARY OF THE INVENTION

It is therefore an object of the present invention to provide an air exhaust valve capable of favorably attenuating noises which are likely to enter from the outside of a vehicle body into the inside of the vehicle body in exhausting air inside the vehicle body to the outside of the vehicle body.

It is another object of the present invention to provide a motor vehicle provided with air exhaust valves.

In order to solve these objects according to the present invention, there is provided an air exhaust valve which includes a valve body including an annular valve seat portion and a plate-shaped valve element extending downward from an upper end portion of the annular valve seat portion so as to open and close the annular valve seat portion, the valve body being configured to open by receiving an air stream flowing toward the annular valve seat portion in a state in which the plate-shaped valve element closes the annular valve seat portion, and a cover body disposed to face or oppose the valve body thereby to exhaust the air stream to the outside through an airflow passage formed over the inside of the valve body and the inside of the cover body.

In the air exhaust valve, the cover body is made of a sound reduction material so as to reduce noises which enter into the cover body through the airflow passage.

In this way, in the air exhaust valve, the cover body is made of a sound reduction material so as to reduce noises which enter into the cover body through the airflow passage. Thus, in a state in which the air exhaust valve is, for instance, mounted on the rear portion on one side of a motor vehicle, when the door of the motor vehicle is opened and is thereafter closed, air inside the vehicle body causes pressure because of the closure of the door and is pushed out and flows as an air flow or stream through the inside of the vehicle body toward the air exhaust valve. Then, the air stream flowing in this manner opens the annular valve seat portion of the valve seat member through the plate-shaped valve element in its process flowing along the airflow passage of the air exhaust valve. Thus, the air stream is exhausted from the vehicle body through the airflow passage.

In the process in which the air exhaust valve exhausts the air stream inside the vehicle body from the vehicle body, the air exhaust valve opens the annular valve seat portion of the valve seat member at the plate-shaped valve element as described above. Therefore, noises from the outside of the vehicle body enter into the air exhaust valve along the airflow passage in the state in which the plate-shaped valve element is opened, and also enters into the cover body.

Herein, the cover body is, as described above, made of a sound reduction material so as to reduce noises which enter along the inner face of the cover body. Thus, the noises enter along the inner face of the cover body, as described above, thereby to be reduced and attenuated favorably by the cover body. This means that, in the air exhaust valve, the cover body exhibits considerably favorable sound reduction ability with the sound reduction material against the noises which enter along the inner face of the cover body.

The air exhaust valve according to the present invention further includes a valve seat member forming the annular valve seat portion. The plate-shaped valve element extends downward from the upper end portion of the annular valve seat portion of the valve seat member so as to open and close the annular valve seat portion, and is supported on the valve seat member from one of both sides of the valve seat member. The cover body has an annular peripheral wall mounted on an outer periphery of the valve seat member from the other side of the both sides of the valve seat member, and a sound reduction cover having a curved shape of convex cross section toward the other side of the valve seat member and disposed on the annular peripheral wall in opposite relation to the annular valve seat portion, from the other side of the valve seat member, and is integrally made of the sound reduction material. An opening portion corresponding to an inner end of the airflow passage is formed in a portion of the sound reduction cover in a position off the portion of the sound reduction cover opposite to the annular valve seat portion.

With this construction, when the door of the motor vehicle is opened and is thereafter closed, in a state in which the air exhaust valve communicates with the inside of the motor vehicle body of the motor vehicle at the opening portion of the sound reduction cover and is mounted on the rear portion on one side of a motor vehicle toward the outside of the vehicle body at the plate-shaped valve element, air inside the vehicle body causes pressure because of the closure of the door, thereby to be pushed out as an air stream and flow through the vehicle body toward the air exhaust valve.

Then, the air stream flowing in this manner flows from the opening portion of the sound reduction cover into the air exhaust valve and passes through the annular valve seat portion of the valve seat member along the airflow passage of the air exhaust valve thereby to open the plate-shaped valve element. Thus, the air stream is exhausted to the outside of the vehicle body through the plate-shaped valve element.

In the process in which the air exhaust valve exhausts the air stream from the inside of the vehicle body to the outside of the vehicle body, the air exhaust valve opens the annular valve seat portion of the valve seat member at the plate-shaped valve element as described above. Therefore, noises from the outside of the vehicle body enter into the sound reduction cover through the annular valve seat portion of the valve seat member by way of the plate-shaped valve element.

Herein, the sound reduction cover is made of the sound reduction material. The sound reduction cover is mounted on the annular peripheral wall in the form of a curved shape of convex cross section so as to oppose to the annular valve seat portion from the other side of the valve seat member. Thus, the noises, which enter into the sound reduction cover as described above, travel along the inner face of the sound reduction cover thereby to be reduced and attenuated favorably by the sound reduction cover.

In particular, the opening portion of the sound reduction cover is formed in the portion of the sound reduction cover in the position off the portion of the sound reduction cover opposite to the annular valve seat portion. Accordingly, the noises, which enter into the sound reduction cover as described above, is incident so as to collide with the portion of the sound reduction cover opposite to the annular valve seat portion, and is reduced and attenuated.

Thus, the noises, which enter into the sound reduction cover as described above, is attenuated favorably. This means that the air exhaust valve exhibits considerably favorable sound reduction ability to the noises entering into the sound reduction cover with the sound reduction cover of the above construction formed from the sound reduction material.

Furthermore, the air exhaust valve according to the present invention includes a valve seat member forming the annular valve seat portion. The plate-shaped valve element extends downward from the upper end portion of the annular valve seat portion of the valve seat member so as to open and close the annular valve seat portion, and is supported on the valve seat member from one of both sides of the valve seat member. The cover body is integrally formed from the sound reduction material so as to have an annular peripheral wall disposed on the outer peripheral portion of the valve seat member correspondingly to the valve seat member from the one side of the valve seat member, and a sound reduction cover mounted on the annular peripheral wall in the form of a curved shape of convex cross section toward the one side of the valve seat member so as to oppose the annular valve seat portion from the one side of the valve seat member. The annular peripheral wall extends at its portion in a sleeve shape from the sound reduction cover as a releasing portion corresponding to the outer end of the airflow passage so as to release the inside of the sound reduction cover to the outside.

With this construction, when the door of the motor vehicle is opened and is thereafter closed, in a state in which the air exhaust valve is mounted on the rear portion on one side of the vehicle body of a motor vehicle such that the sound reduction cover and the valve body are opposite to each other from the outside and the inside, air inside the vehicle body causes pressure because of the closure of the door is pushed out as an air stream thereby to flow through the vehicle body toward the air exhaust valve.

Then, the air stream flowing in this manner opens the plate-shaped valve element from the annular valve seat portion of the valve seat member and passes through the annular valve seat portion along the airflow passage of the air exhaust valve, and further enters into the sound reduction cover. Thus, the air stream flows along the inner face of the sound reduction cover and is exhausted from the rear portion on one side of the vehicle body through the releasing portion of the sound reduction cover.

In the process in which the air exhaust valve exhausts the air stream inside the vehicle body from the vehicle body, the air exhaust valve opens the annular valve seat portion of the valve seat member with the plate-shaped valve element as described above. Therefore, noises from the outside of the vehicle body enter from the releasing portion into the sound reduction cover, pass through the annular valve seat portion of the valve seat member along the airflow passage, and further enter into the vehicle body through the annular valve seat portion.

Herein, as described above, the sound reduction cover is made of the sound reduction material to oppose the annular valve seat portion from the one side of the valve seat member in the form of a curved shape of convex cross section. Thus, the noises entering into the sound reduction cover as described above, travels along the inner face of the sound reduction cover thereby to be reduced and attenuated favorably by the sound reduction cover. This means that the air exhaust valve exhibits considerably favorable sound reduction ability with the sound reduction material to the noises entering along the inner face of the sound reduction cover.

Still further, in the air exhaust valve according to the present invention, the sound reduction cover bulges from the inner peripheral end portion of the annular peripheral wall to the other side of the valve seat member in a curved shape of convex cross section so as to be opposite to the annular valve seat portion, the sound reduction cover forming a lower opening portion as the opening portion at its lower wall portion.

In this way, the lower opening portion of the sound reduction cover is formed in the lower wall portion of the sound reduction cover. Thus, an air stream flowing into the air exhaust valve flows into the sound reduction cover from the lower wall portion of the sound reduction cover through the lower opening portion thereof and is thereafter exhausted to the outside through the annular valve seat portion of the valve seat member by way of the plate-shaped valve element.

Herein, the sound reduction cover is made of the sound reduction material. And, the sound reduction cover bulges toward the other side of the valve seat member in a curved shape of convex cross section so as to cover the annular valve seat portion from the other side of the valve seat member.

Therefore, noises which enter into the sound reduction cover through the plate-shaped valve member in a state of opening the annular valve seat portion of the valve seat member travel along the inner face of the sound reduction cover, thereby to be reduced and attenuated by the sound reduction cover.

Moreover, the lower opening portion of the sound reduction cover is formed in the lower wall portion of the sound reduction cover, thereby to be located off the position opposite to the annular valve seat portion of the valve seat member. Thus, the noises which enter into the sound reduction cover as described above is incident into an opposing portion of the sound reduction cover to the annular valve seat portion so as to collide with the opposing portion of the sound reduction cover, and are reduced and attenuated favorably.

This means that the air exhaust valve exhibits considerably favorable sound reduction ability with the sound reduction cover to the noises entering into the sound reduction cover.

Furthermore, the air exhaust valve according to the present invention includes a valve seat member forming the annular valve seat portion. The plate-shaped valve element extends downward from the upper end portion of the annular valve seat portion of the valve seat member so as to open and close the annular valve seat portion, and is supported on the valve seat member from one of both sides of the valve seat member. The cover body includes first and second sound reduction cover members.

The first sound reduction cover member has an annular peripheral wall mounted on the outer peripheral portion of the valve seat member from the other side of the both sides of the valve seat member, and a sound reduction cover bulging from the inner peripheral end portion of the annular peripheral wall to the other side of the valve seat member in a curved shape of convex cross section so as to cover the annular valve seat portion, the sound reduction cover forming a first opening portion at its opposing wall portion to the valve seat member.

The second sound reduction cover member has an annular peripheral wall mounted on the annular peripheral wall of the first sound reduction cover member from the other side of the valve seat member, and a sound reduction cover bulging from the inner peripheral end portion of the annular peripheral wall to the other side of the valve seat member in a curved shape of convex cross section so as to cover the first sound reduction cover member.

A second opening portion is formed at an opposing portion of the sound reduction cover of the second sound reduction cover member to the valve seat member in the position off the first opening portion so as to correspond to the inner end of the airflow passage together with the first opening portion.

With this construction, the cover body has the first and second sound reduction cover members with the above-mentioned construction. Based on this construction, when air inside the vehicle body causes pressure because of the closure of the door of the motor vehicle, is then pushed out and flows as an air stream through the interior of the vehicle body toward the air exhaust valve, in a state in which the air exhaust valve is mounted on the one side rear portion of the vehicle body of a motor vehicle so as to communicate with the inside of the vehicle body of the motor vehicle at the second opening portion of the sound reduction cover of the second sound reduction cover member and to direct to the outside of the vehicle body at the plate-shaped valve element, the air stream flowing in this manner flows from the second opening portion of the sound reduction cover of the second sound reduction cover member and the first opening portion of the sound reduction cover of the first sound reduction cover member into the air exhaust valve, further flows through the annular valve seat portion of the valve seat member, thereby to open the plate-shaped valve element. Thus, the air stream is exhausted from the vehicle body through the plate-shaped valve element.

In the process in which the air exhaust valve exhausts the air stream from the inside the vehicle body to the outside of the vehicle body, the air exhaust valve opens the annular valve seat portion of the valve seat member with the plate-shaped valve element as described above.

Herein, since the first and second sound reduction cover members are made of the sound reduction material, the first and second sound reduction covers are also made of the sound reduction material. And, the sound reduction cover of the first sound reduction cover member is mounted so as to cover the annular valve seat portion from the other side of the valve seat member in the form of a curved shape of convex cross section. Further, the sound reduction cover of the second sound reduction cover member is mounted so as to cover the sound reduction cover of the first sound reduction cover member in the form of a curved shape of convex cross section.

Therefore, when noises from the outside of the vehicle body enter from the plate-shaped valve element into the sound reduction cover of the first sound reduction cover member through the annular valve seat portion of the valve seat member, the noises travel along the inner face of the sound reduction cover of the first sound reduction cover member, thereby to be reduced and attenuated by the sound reduction cover of the first sound reduction cover member.

Furthermore, the first sound reduction cover member, which has the first opening portion, is opposite to the annular valve seat portion, not only at the first opening portion, but also at the portion of the sound reduction cover of the first sound reduction cover member around the first opening portion. Therefore, the noises entering into the sound reduction cover of the first sound reduction cover member as described above is incident so as to collide with the portion of the first sound reduction cover member around the first opening portion, thereby to be absorbed and attenuated by the portion of the first sound reduction cover member around the first opening portion.

This means that the sound reduction cover of the first sound reduction cover member exhibits favorable sound reduction ability under the above construction to the noises entering into the sound reduction cover.

And, the first sound reduction cover member has the first opening portion as described above. Therefore, part of the noises entering into the sound reduction cover of the first sound reduction cover member enters into the second sound reduction cover member through the first opening portion.

The second sound reduction cover member is also made of the sound reduction material like the first sound reduction cover member. And, the second sound reduction cover member bulges to the other side of the valve seat member so as to cover the sound reduction cover of the first sound reduction cover member, so that the sound reduction cover of the second sound reduction cover member covers the sound reduction cover of the first sound reduction cover member from the other side of the valve seat member at the portion of the sound reduction cover except for the second opening portion. Therefore, the noises entering into the sound reduction cover of the second sound reduction cover member through the first opening portion as described above is reduced and attenuated by the sound reduction cover of the second sound reduction cover member.

Further, the second sound reduction cover member is located at its second opening portion off the first opening portion of the first sound reduction cover member. Therefore, the noises, which enter from the first opening portion of the first sound reduction cover member into the sound reduction cover of the second sound reduction cover member as described above, are incident so as to collide with the portion of the sound reduction cover of the second sound reduction cover member around the second opening portion, and are reduced by the portion of the sound reduction cover of the second sound reduction cover member around the second opening portion. Thus, the noises, which enter into the sound reduction cover of the second sound reduction cover member as described above, are reduced and attenuated favorably by the sound reduction cover of the second sound reduction cover member.

This means that the second sound reduction cover member having the above construction also exhibits favorable sound reduction ability with regard to the noises which enter into the second sound reduction cover member.

As described above, in the air exhaust valve, the cover body has the first and second sound reduction cover members having the above construction, so that the noises can be reduced and attenuated more favorably by the synergistic sound reduction ability of the sound reduction covers of the first and second sound reduction cover members.

In the air exhaust valve according to the present invention, the sound reduction cover is a sound absorption and shield cover formed of a three-layer structure including a barrier film made of a thermoplastic resin material, and a first film and a second film bonded by fusion to the barrier film from both sides of the barrier film, and made of a thermoplastic material which is lower in melting point than the thermoplastic resin material.

With this construction, the barrier film, the first film, and the second film are thin, so that the sound absorption and shield cover has favorable sound absorption ability by the three-layer structure. Since the barrier film, the first film, and the second film have non-air permeability, the sound absorption and shield cover has favorable sound shield ability by the three-layer structure.

Thus, noises, which enter into the sound absorption and shield means, are absorbed, shielded, and attenuated more favorably by the three-layer structure of the sound absorption and shield cover. As a result, the operations and effects of the invention are further improved.

A motor vehicle according to the present invention includes a vehicle body, a rear bumper disposed on a rear portion of the vehicle body, and an air exhaust valve mounted on the rear portion of the vehicle body.

In the motor vehicle, the air exhaust valve is air exhaust valve including a valve body (B, Ba, Bb) including an annular valve seat portion, and a plate-shaped valve element extending downward from an upper end portion of the annular valve seat portion so as to open and close the annular valve seat portion, the valve body being configured to open by receiving an air stream flowing toward the annular valve seat portion in a state in which the plate-shaped valve element closes the annular valve seat portion, and a cover body opposite to the valve body, and exhausting the air stream to the outside through an airflow passage formed over the inside of the valve body and the inside of the cover body. The cover body is made of a sound reduction material so as to reduce noises which enter from the outside of the rear portion of the vehicle body into the cover body along the airflow passage.

With this construction, it is possible to provide the motor vehicle which includes the air exhaust valve and achieves the operations and effects of the air exhaust valve.

In the motor vehicle according to the present invention, the air exhaust valve includes a valve seat member formed with the annular valve seat portion. The plate-shaped valve element extends downward from the upper end portion of the annular valve seat portion of the valve seat member so as to open and close the annular valve seat portion, and is supported on the valve seat member from one of both sides of the valve seat member. The cover body has an annular peripheral wall mounted on an outer periphery of the valve seat member from the other side of the both sides of the valve seat member, and a sound reduction cover having a curved shape of convex cross section toward the other side of the valve seat member and disposed on the annular peripheral wall in opposite relation to the annular valve seat portion from the other side of the valve seat member, and is integrally made of the sound reduction material. An opening portion corresponding to an inner end of the airflow passage is formed in a portion of the sound reduction cover in a position off the portion of the sound reduction cover opposite to the annular valve seat portion. The plate-shaped valve element of the air exhaust valve is positioned toward the outside of the rear portion of the vehicle body, and communicates with the inside of the vehicle body at the opening portion of the sound reduction cover.

With this construction, it is possible to provide the motor vehicle which includes the air exhaust valve and achieves the operations and effects of the air exhaust valve.

In the motor vehicle according to the present invention, the vehicle body has, at each side portion of the rear portion of the vehicle body, rear plates of an outer plate and an inner plate inside the outer plate. The air exhaust valve includes a valve seat member formed with the annular valve seat portion. The plate-shaped valve element extends downward from the upper end portion of the annular valve seat portion of the valve seat member so as to open and close the annular valve seat portion, and is supported on the valve seat member from one of both sides of the valve seat member. The cover body has an annular peripheral wall disposed on the outer periphery of the valve seat member for corresponding to the valve seat member, from the one side of the valve seat member, and a sound reduction cover having a curved shape of convex cross section toward the one side of the valve seat member and disposed on the annular peripheral wall in opposite relation to the annular valve seat portion from the one side of the valve seat member, and is integrally made of the sound reduction material. The annular peripheral wall extends in a sleeve shape from the sound reduction cover at part of the annular peripheral wall, as a releasing portion corresponding to the outer end of the airflow passage and releasing the inside of the sound reduction cover to the outside. The cover body and the valve body of the air exhaust valve are mounted so as to be opposite to each other, from the outside and the inside, via an opening portion formed in the rear plate of the outer plate in such a manner that the plate-shaped valve element is positioned on the rear plate side of the inner plate and that the releasing portion is positioned along the rear side of the rear portion of the vehicle body.

With this construction, it is possible to provide the motor vehicle which includes the air exhaust valve and achieves the operations and effects of the air exhaust valve.

As described above, the releasing portion of the cover body is positioned along the rear side of the rear portion of the vehicle body. Thus, the releasing portion is farther from the rear wheel of the motor vehicle than the side portion of the rear portion of the vehicle body. Therefore, noises which are caused from the rear wheel at driving the motor vehicle is hard to reach the releasing portion of the cover body. Thus, the noises, which enter from the releasing portion into the cover body, are attenuated more favorably by the releasing portion farther from the rear wheel of the motor vehicle than the side position of the rear portion of the vehicle body. As a result, the noises are reduced more favorably by the sound reduction material for the cover body.

### BRIEF DESCRIPTION OF THE DRAWINGS

Other features and advantages of the invention will be apparent from the following description taken in connection with the accompanying drawings.

FIG. 1 is a′schematic plan view illustrating an motor vehicle according to a first embodiment of the present invention.

FIG. 2 is an enlarged perspective view illustrating an air exhaust valve according to the first embodiment.

FIG. 3 is a longitudinal sectional perspective view illustrating the air exhaust valve in FIG. 2.

FIG. 4 is a longitudinal sectional view illustrating the air exhaust valve in FIG. 2.

FIG. 5 is a longitudinal sectional exploded perspective view illustrating the air exhaust valve in FIG. 2.

FIG. 6 is a schematic enlarged longitudinal sectional view of the rear portion on the right side of a vehicle body of assistance in explaining the exhaustion of each air stream from the inside of the vehicle body of the motor vehicle by the air exhaust valve in FIG. 1.

FIG. 7 is a schematic enlarged longitudinal sectional view of the rear portion on the right side of the vehicle body of assistance in explaining the intrusion of noises from the outside of the motor vehicle into the air exhaust valve in FIG. 6.

FIG. 8 is a schematic enlarged longitudinal sectional view of the rear portion on the right side of the vehicle body of assistance in explaining the exhaustion of each air stream from the inside of the vehicle body by a conventional air exhaust valve.

FIG. 9 is a schematic enlarged longitudinal sectional view of the rear portion on the right side of the vehicle body of assistance in explaining the intrusion of noises from the outside of the motor vehicle into the conventional air exhaust valve in FIG. 8.

FIG. 10 illustrates graphs of the sound absorption characteristics of the air exhaust valve in FIG. 1 according to the first embodiment and comparative examples, at absorbing noises from the outside of the motor vehicle, in accordance with the relation between the noise levels and the frequencies.

FIG. 11 is a longitudinal sectional view illustrating an air exhaust valve according to a second embodiment of the present invention.

FIG. 12 is a longitudinal sectional enlarged perspective view illustrating an air exhaust valve according to a third embodiment of the present invention.

FIG. 13 is a longitudinal sectional view illustrating the air exhaust valve in FIG. 12.

FIG. 14 is a longitudinal sectional exploded perspective view illustrating the air exhaust valve in FIG. 12.

FIG. 15 is a schematic sectional view illustrating major parts of an motor vehicle according to a fourth embodiment of the present invention.

FIG. 16 is an enlarged perspective view illustrating a valve body of an air exhaust valve in FIG. 15.

FIG. 17 is a longitudinal sectional enlarged perspective view of the valve body in FIG. 16.

FIG. 18 is an enlarged perspective view illustrating a cover member of the air exhaust valve in FIG. 15.

FIG. 19 is a longitudinal sectional enlarged perspective view of the cover member in FIG. 18.

FIG. 20 illustrates graphs of the sound transmission loss characteristics of the air exhaust valve in FIG. 15 according to the fourth embodiment and the air exhaust valve in FIG. 2 according to the first embodiment, in accordance with the relation between the sound transmission loss and the frequencies.

FIG. 21 illustrates graphs of the sound transmission loss characteristics of the air exhaust valve in FIG. 15 according to the fourth embodiment and the air exhaust valve in FIG. 2 according to the first embodiment, in accordance with the relation between the sound transmission loss and the frequencies.

### DETAILED DESCRIPTION OF THE PREFFERED EMBODIMENTS

Hereinafter, respective embodiments of the present invention will be described below, referring to the attached drawings.

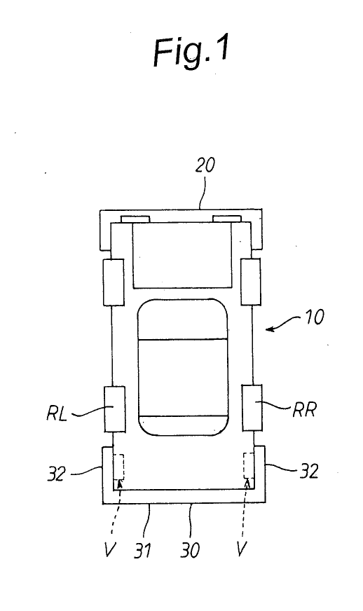

FIG. 1 illustrates a motor vehicle according to a first embodiment of the present invention. The motor vehicle includes a vehicle body 10, a front bumper 20 at the front portion of the vehicle body 10, and a rear bumper 30 at the rear portion of the vehicle body 10.

In the first embodiment, the rear bumper 30 has a widthwise middle portion 31 supported along the rear portion of the vehicle body 10, and left and right portions 32 bent from the left and right ends of the widthwise middle portion 31 to the front side of the vehicle body 10 and extending along the rear portions on the left and right sides of the vehicle body 10.

The left and right portions 32 of the rear bumper 30 are positioned near left and right rear wheels RL, RR of the motor vehicle, respectively. The left, right, upper, and lower sides in FIG. 1 correspond to the left, right, front, and rear sides of the motor vehicle.

As illustrated in FIG. 1, the vehicle body 10 has the left and right air exhaust valves V. The left and right air exhaust valves V are mounted on the rear portions on the left and right sides of the vehicle body 10.

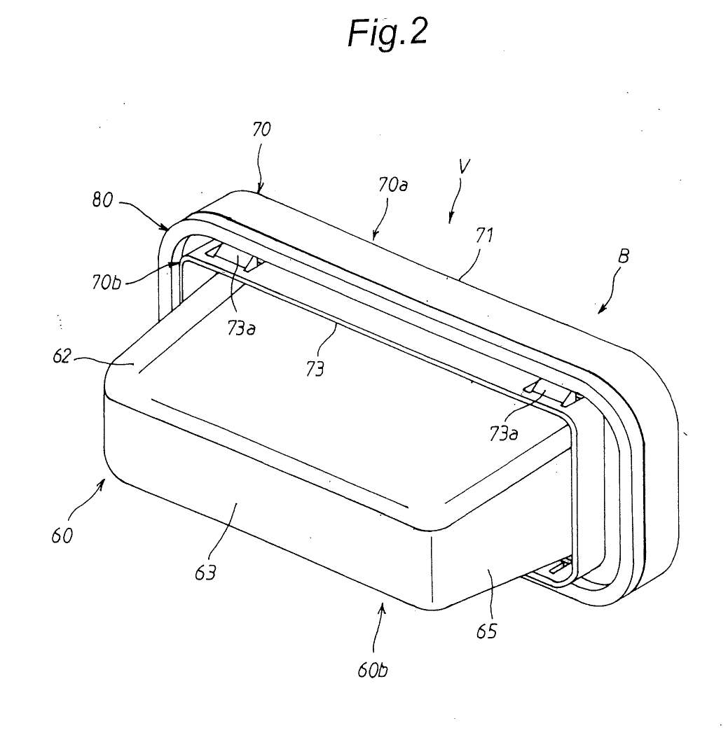

The construction of the right air exhaust valve V of the left and right air exhaust valves V will be described. As illustrated in any one of FIGS. 2 to 5, the right air exhaust valve V has a valve seat member 40, a plate-shaped valve element 50, a cover member 60, amounting member 70, and a ring-shaped gasket 80. The valve seat member 40, the plate-shaped valve element 50, the mounting member 70, and the ring-shaped gasket 80 form valve body B of the right air exhaust valve V.

In the first embodiment, the valve seat member 40, the plate-shaped valve element 50, the cover member 60, the mounting member 70, and the ring-shaped gasket 80 of the right air exhaust valve V are, hereinafter, also called a right valve seat member 40, a right plate-shaped valve element 50, a right cover member 60, a right mounting member 70, and aright ring-shaped gasket 80, respectively. The diagonally forward left side, the diagonally rearward right side, the diagonally forward right side, the diagonally rearward left side, the upper side, and the lower side in FIG. 2 correspond to the front side (the inside of the motor vehicle), the rear side (the outside of the motor vehicle), the right side, the left side, the upper side, and the lower side of the right air exhaust valve V, respectively.

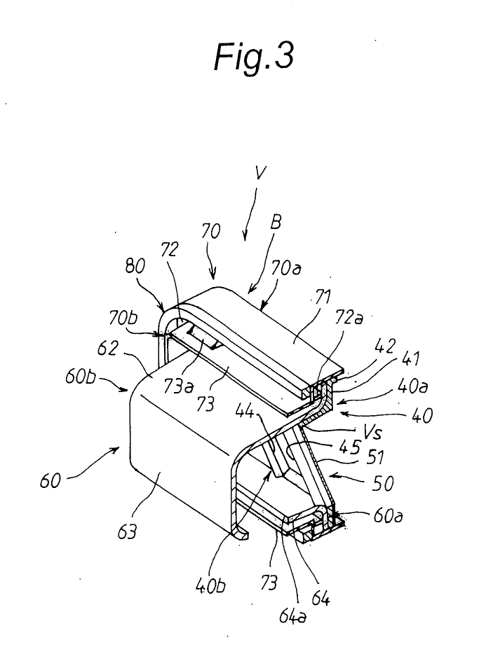

As illustrated in any one of FIGS. 3 to 5, the right valve seat member 40 forms, at an annular valve seat portion Vs (described later), the valve portion of the right air exhaust valve V together with the right plate-shaped valve element 50. The right valve seat member 40 is mounted into a mounting frame 70a (described later) of the right mounting member 70 from the rear side together with an annular peripheral wall 60a (described later) of the right cover member 60.

The right valve seat member 40 has an outer peripheral frame 40a and a partition mechanism 40b, and is made of a synthetic resin material (e.g., polypropylene). The outer peripheral frame 40a has a valve seat portion wall 41, an annular flange 42 extending from the outer periphery of the valve seat portion wall 41 to the rear side (or to the outside of the motor vehicle) and bent in an L shape, and an inverted U-shaped wall 43 disposed in the hollow portion of the valve seat portion wall 41.

The outer peripheral frame 40a is mounted, at the outer periphery of the valve seat portion wall 41, into the mounting frame 70a (described later) of the right mounting member 70 from the rear side together with the annular peripheral wall 60a of the right cover member 60.

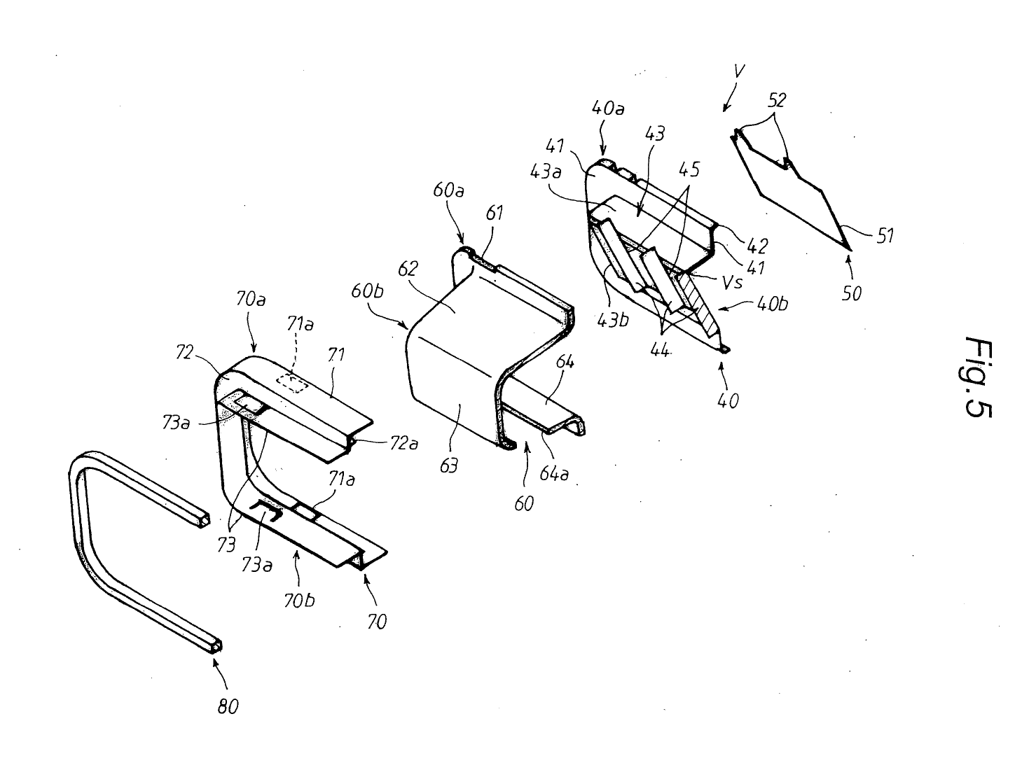

As illustrated in FIG. 5, the inverted U-shaped wall 43 extends from the peripheral end portion of the hollow portion of the valve seat portion wall 41 to the front side (or to the inside of the motor vehicle). The inverted U-shaped wall 43 has an upper wall 43a and left and right walls 43b (FIG. 5 illustrates only the right wall 43b) extending downward from the left and right ends of the upper wall 43a, and is formed in an inverted U shape.

The upper wall 43a extends from the upper end portion of the peripheral end portion of the hollow portion of the valve seat portion wall 41 to the front side. The left and right walls 43b extend from the left and right end portions of the peripheral end portions of the hollow portion of the valve seat portion wall 41, to the front side. As illustrated in FIG. 5, the left and right walls 43b are inclined, at the front extending end portions thereof, from the front ends of the left and right ends of the upper wall 43a to the left and right ends of the lower end portion of the peripheral end portion of the hollow portion of the valve seat portion wall 41.

The partition mechanism 40b is disposed in the inverted U-shaped wall 43 of the outer peripheral frame 40a. The partition mechanism 40b has a plurality of section walls 44. The plurality of section walls 44 are fixed, at the upper and lower ends thereof, to the upper wall 43a of the inverted U-shaped wall 43 and the lower end portion of the peripheral end portion of the hollow portion of the valve seat portion wall 41, and are inclined so as to be spaced from each other in a widthwise direction.

This means that the plurality of section walls 44 section an inclined space formed between the front end of the upper wall 43a and the front ends of the left and right walls 43b of the inverted U-shaped wall 43 and the lower end portion of the peripheral end portion of the hollow portion of the valve seat portion wall 41, and divides the inclined space into a plurality of communication ports 45 spaced from each other in the widthwise direction. In the first embodiment, the inclined space is formed as the annular valve seat portion Vs as described later.

The right plated-shaped valve element 50 has a valve element body 51, and a plurality of connection portions 52 projecting upward from the upper end portion of the valve element body 51 and spaced from each other, and is integrally made of rubber.

The connection portions 52 of the right plate-shaped valve element 50 are connected, at the lower sides thereof, to the front end portion of the upper wall 43a of the inverted U-shaped wall 43. The valve element body 51 of the right plate-shaped valve element 50 extends downward along the inclined space. The valve element body 51 is swingable in the plate thickness direction thereof. This means that, with the inclined space as the annular valve seat portion Vs, the right plate-shaped valve element 50 is supported on the outer peripheral frame 40a so as to be seatable on the annular valve seat portion Vs.

The right plate-shaped valve element 50 constructed in this manner is seated, at the valve element body 51, on the annular valve seat portion Vs from the rear side (or from the outside of the motor vehicle), thereby closing the connection ports 45 of the partition mechanism 40b. This inhibits air inside the vehicle body 10 (or inside the motor vehicle) from being exhausted from the vehicle body 10 (or the motor vehicle).

The right plate-shaped valve element 50 is separated from the annular valve seat portion Vs to the rear side, at the valve element body 51, thereby opening the connection ports 45. This exhausts an air stream from the inside of the motor vehicle to the outside of the motor vehicle. In the first embodiment, the right plate-shaped valve element 50 is also called a shield plate, and does not exhibit sound absorption ability.

As illustrated in any one of FIGS. 2 to 5, the right cover member 60 has the annular peripheral wall 60a fitted into the mounting frame 70a (described later) of the right mounting member 70, and a sound absorption cover 60b, and is integrally made of a fiber sound absorption material. In the first embodiment, as the fiber sound absorption material, e.g., a porous material, such as felt, and polyethylene terephthalate are given.

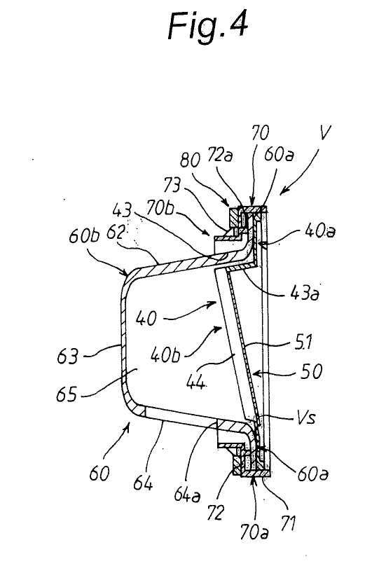

The sound absorption cover 60b bulges, in a U-shaped cross section, from the inner peripheral end portion of the annular peripheral wall 60a to the front side (or to the inside of the motor vehicle). The sound absorption cover 60b has an upper wall 62, a front wall 63, a lower wall 64, and left and right walls 65 (see FIG. 2 or 4), and is formed in a U-shaped lateral cross section.

As illustrated in FIG. 3 or 4, the lower wall 64 has an opening portion 64a (hereinafter, also called a lower opening portion 64a). The lower opening portion 64a communicates the communication ports 45 of the partition mechanism 40b, with the lower side of the lower wall 64. The left and right walls 65 are integrally formed, at the left and right sides thereof, with the upper wall 62, the front wall 63, and the lower wall 64. Thus, the sound absorption cover 60b is closed except for the lower and rear sides thereof.

In the right cover member 60 constructed in this manner, an air stream from the inside of the vehicle body 10 flows from the lower opening portion 64a into the sound absorption cover 60b, is guided by the sound absorption cover 60b along the inner face thereof, and flows toward the communication ports 45 of the valve seat member 40.

As illustrated in FIG. 5, the right mounting member 70 has the mounting frame 70a, and an annular flange 70b, and is integrally made of a synthetic resin material (e.g., polypropylene).

The mounting frame 70a has an annular peripheral wall 71, and an annular front wall 72 extending from the annular peripheral wall 71 to the inside thereof and bent in an L shape. A plurality of pairs of claws 71a (FIG. 5 illustrates only a pair of claws 71a) are formed on the annular peripheral wall 71. The plurality of pairs of claws 71a engage into concave cutaway portions 61 (FIG. 5 illustrates only one concave cutaway portion 61) formed at the longitudinal ends of the upper and lower end portions of the annular peripheral wall 60a.

The annular flange 70b extends from the inner peripheral end portion of the annular front wall 72 of the mounting frame 70a to the front side (or to the inside of the motor vehicle). A plurality of pairs of claws 73a (FIG. 5 illustrates only a pair of claws 73a) are formed on upper and lower walls 73 of the annular flange 70b. The plurality of pairs of claws 73a are lanced outward at the left and right ends of the upper and lower walls 73 of the annular flange 70b (see FIGS. 2 and 5).

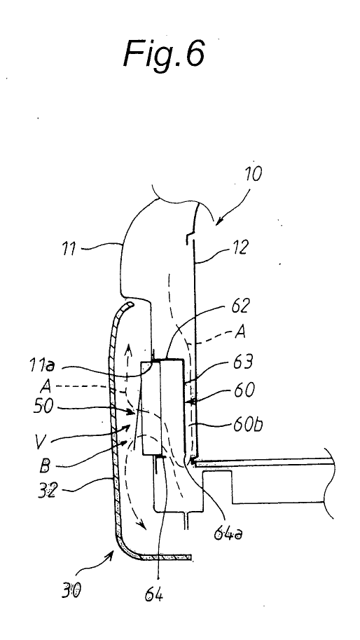

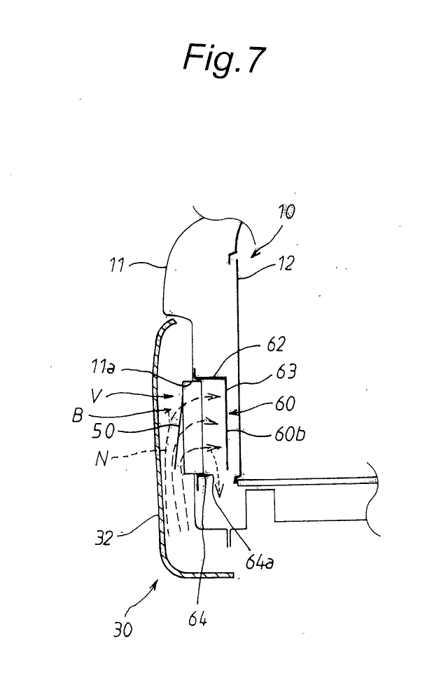

Mounting bores 11a are formed in the outer plate portions corresponding to the rear portions of left and right outer plates 11 of the vehicle body 10. In FIGS. 6 and 7, the right mounting member 70 is fitted, at the annular flange 70b, into the mounting bore 11a formed in the outer plate portion corresponding to the rear portion of the right outer plate 11 of the vehicle body 10, via the right gasket 80. When the right mounting member 70 is contacted, at the annular front wall 72 of the mounting frame 70a, onto the outer periphery of the mounting bore 11a, via the gasket 80, the plurality of pairs of claws 73a of the annular flange 70b engage into a plurality of pairs of concave cutaway portions of the mounting bore 11a, against the resilient force thereof. This means that the right air exhaust valve V is mounted on the rear portion on the right side of the vehicle body 10 through the mounting bore 11a.

The plurality of pairs of concave cutaway portions of the mounting bore 11a (hereinafter, also called a right mounting bore 11a) into which the annular flange 70b of the right mounting member 70 is fitted, are formed at the inner peripheral end portion of the right mounting bore 11a, so as to correspond to the plurality of pairs of claws 73a of the annular flange 70b. The left side in FIGS. 6 and 7 corresponds to the left side of the vehicle body 10.

The right mounting member 70 constructed as above is mounted, on the outer plate portion of the rear portion on the right outer plate 11 of the vehicle body 10 in air-tight and liquid-tight manner via the right gasket 80. The right gasket 80 is interposed between the outer plate portion of the rear portion on the right outer plate 11 of the vehicle body 10 and the annular front wall 72 of the mounting frame 70a. The vehicle body 10 has the outer plate 11, and an inner plate 12 (see FIGS. 6 and 7) inside the outer plate 11 and in parallel with and spaced from the outer plate 11. In the first embodiment, the passage from the annular valve seat portion Vs to the opening portion 64a of the cover member 60 in the right air exhaust valve V is also called an airflow passage for the air stream (see each arrow A in FIG. 6).

The left air exhaust valve V is equal in construction to the right air exhaust valve V. Thus, the left air exhaust valve V has a left valve seat member 40, a left plate-shaped valve element 50, a left cover member 60, a left mounting member 70, and a left ring-shaped gasket 80, which are equal in construction to the valve seat member 40, the plate-shaped valve element 50, the cover member 60, the mounting member 70, and the ring-shaped gasket 80 of the right air exhaust valve V, respectively.

The left valve seat member 40, the left plate-shaped valve element 50, the left cover member 60, the left mounting member 70, and the left ring-shaped gasket 80 are equal in mounting construction to the valve seat member 40, the plate-shaped valve element 50, the cover member 60, the mounting member 70, and the ring-shaped gasket 80 of the right air exhaust valve V. Thus, the mounting construction of the left air exhaust valve V is equal to the mounting construction of the right air exhaust valve V.

In the left air exhaust valve V mounted in this manner, the left mounting member 70 is fitted, at the annular flange 70b, into the mounting bore 11a formed in the outer plate portion corresponding to the rear portion of the left outer plate 11 of the vehicle body 10 (hereinafter, called a left mounting bore 11a) via the left gasket 80. When the left mounting member 70 is contacted, at the annular front wall 72 of the mounting frame 70a, onto the outer periphery of the left mounting bore 11a via the left gasket 80, the plurality of pairs of claws 73a of the annular flange 70b engage into the plurality of pairs of concave cutaway portions of the left mounting bore 11a against the resilient force thereof. This means that the left air exhaust valve V is mounted through the mounting bore 11a on the rear portion on the left side of the vehicle body 10. The plurality of pairs of concave cutaway portions of the left mounting bore 11a are formed at the inner peripheral end portion of the left mounting bore 11a so as to correspond to the plurality of pairs of claws 73a of the annular flange 70b.

In the first embodiment constructed as above, when the left and right air exhaust valves V are mounted on the rear portions on the left and right sides (see FIG. 1) of the vehicle body 10 of the motor vehicle as described above in the left air exhaust valve V, the left mounting member 70 is fitted, at the annular flange 70b, into the left mounting bore 11a of the outer plate 11 of the vehicle body 10 via the left gasket 80. In the right air exhaust valve V, the right mounting member 70 is fitted, at the annular flange 70b, into the right mounting bore 11a of the outer plate 11 of the vehicle body 10 via the right gasket 80.

With this, in the left air exhaust valve V, the left mounting member 70 is contacted, at the annular front wall 72 of the mounting frame 70a, onto the outer periphery of the mounting bore 11a from the front side via the left gasket 80. The plurality of pairs of claws 73a of the annular flange 70b of the left mounting member 70 engage into the plurality of pairs of concave cutaway portions of the left mounting bore 11a against the resilience thereof. Thus, the left mounting member 70 is mounted into the mounting bore 11a in the rear portion on the left outer plate 11 of the vehicle body 10 in air-tight and liquid-tight manner via the left gasket 80.

In the right air exhaust valve V, the right mounting member 70 is contacted, at the annular front wall 72 of the mounting frame 70a, onto the outer periphery of the mounting bore 11a from the front side via the right gasket 80. The plurality of pairs of claws 73a of the annular flange 70b of the right mounting member 70 engage into the plurality of pairs of concave cutaway portions of the right mounting bore against the resilience thereof. Thus, the right mounting member 70 is mounted into the mounting bore in the rear portion on the right outer plate 11 of the vehicle body 10 in air-tight and liquid-tight manner via the right gasket 80.

In such a mounted state, in the left air exhaust valve V, the left cover member 60 projects, at the sound absorption cover 60b, to between the outer plate 11 and the inner plate 12 of the vehicle body 10 through the mounting bore 11a in the rear portion of the left outer plate 11 of the vehicle body 10 (see FIGS. 6 and 7). Thus, the sound absorption cover 60b communicates, at the lower opening portion 64a of the lower wall 64, with the inside of a space passage between the outer plate 11 and the inner plate 12.

In the right air exhaust valve V, the right cover member 60 projects, at the sound absorption cover 60b, to between the outer plate 11 and the inner plate 12 of the vehicle body 10 through the mounting bore in the rear portion on the right outer plate 11 of the vehicle body 10. Thus, the sound absorption cover 60b communicates, at the lower opening portion 64a of the lower wall 64, with the inside of a space passage between the outer plate 11 and the inner plate 12.

In the left air exhaust valve V, the space passage between the outer plate 11 and the inner plate 12 communicates with the inside of the communication ports 45 of the left valve seat member 40 through the opening portion 64a of the sound absorption cover 60b. At this time, the left plate-shaped valve element 50 closes, at the valve element body 51, the annular valve seat portion Vs, that is, the communication ports 45 of the left valve seat member 40. In the right air exhaust valve V, the space passage between the outer plate 11 and the inner plate 12 communicates with the inside of the communication ports 45 of the right valve seat member 40 through the opening portion 64a of the sound absorption cover 60b. At this time, the right plate-shaped valve element 50 closes, at the valve element body 51, the annular valve seat portion Vs, that is, the communication ports 45 of the right valve seat member 40.

This means that each of the left and right air exhaust valves V shields, at the valve portion thereof, the space passage between the outer plate 11 and the inner plate 12 of the vehicle body 10 of the motor vehicle from the outside of the vehicle body 10. The space passage communicates with the inside of the vehicle compartment of the vehicle body 10.

Each of the left and right mounting members 70 is opposite to each of the left and right portions 32 of the rear bumper 30 at the inner face side thereof together with each of the left and right plate-shaped valve elements 50. Thus, each of the left and right air exhaust valves V is not seen from the outside of the motor vehicle. Each of the left and right air exhaust valves V does not deteriorate the appearance of the motor vehicle.

When the motor vehicle on which the left and right air exhaust valves V are mounted, as described above, is driven and is then stopped, and the passenger opens the door of the vehicle body 10 of the motor vehicle, gets off, and closes the door, air inside the vehicle compartment of the vehicle body 10 causes pressure (air pressure) in the inside of the vehicle body 10 because of the closure of the door, as described above.

As indicated by each arrow A in FIG. 6, the air which causes the air pressure is pushed out as an air stream, with the closing of the door, and flows toward each of the left and right air exhaust valves V mounted on the rear portion on each of the left and right outer plates 11 of the vehicle body 10 through the space passage of the vehicle body 10.

Then, the air stream flows from the lower opening portion 64a into the sound absorption cover 60b of each of the left and right air exhaust valves V, and then flows toward the communication ports 45 of each valve seat member 40. Then, the air stream flows through the communication ports 45 (see FIG. 3) and the annular valve seat portion Vs, and pushes the valve element body 51 of each of the left and right plated-shaped valve elements 50 to the rear side (or to the outside of the motor vehicle). With this, each of left and right plate-shaped valve elements 50 swings, at the valve element body 51, to the rear side (or to the outside of the motor vehicle) relative to the connection portions 52, thereby opening the annular valve seat portion Vs (see FIG. 3) of each of the left and right valve seat members 40. This means that the valve portion of each of the left and right air exhaust valves V is opened.

Thus, as described above, the air stream which flows through the communication ports 45 and the annular valve seat portion Vs of each of the left and right valve seat members 40 flows from between the valve element body 51 of each of the left and right plated-shaped valve elements 50 and each valve seat portion wall 41 to the rear side. This means that the air stream inside the vehicle compartment of the vehicle body 10 is exhausted from the motor vehicle by each of the left and right air exhaust valves V.

When each of the left and right air exhaust valves V exhausts the air stream inside the vehicle compartment of the vehicle body 10 from the motor vehicle, the plate-shaped valve element 50 of each of the left and right air exhaust valves V swings to the outside of the motor vehicle, thereby opening each annular valve seat portion Vs, that is, the communication ports 45.

In such a state, noises from the outside of the vehicle body 10 (or from the outside of the motor vehicle) (e.g., road noises from each of left and right rear wheels RL, RR) enter from between each of the left and right plate-shaped valve elements 50 and the corresponding valve seat portion wall 41 through the hollow portion of the corresponding valve seat portion wall 41, the corresponding annular valve seat portion Vs, and the communication ports 45 into the sound absorption cover 60b of each of the left and right sound absorption members 60 (see each arrow indicated by reference sign N in FIG. 7).

As described above, the sound absorption cover 60b of each of the left and right sound absorption members 60 is made of the fiber sound absorption material. Since the sound absorption cover 60b of each of the left and right sound absorption members 60 bulges, in a U-shaped cross section, from the inner peripheral end portion of the annular peripheral wall 60a to the front side, the sound absorption cover 60b covers, at the portion of the sound absorption cover 60b except for the lower opening portion 64a, the hollow portion of the annular peripheral wall 60a, that is, the communication ports 45 and the annular valve seat portion from the inside of the motor vehicle. Thus, the noises which enter into the sound absorption cover 60b, as described above, travels along the inner peripheral face of the sound absorption cover 60b, and is absorbed by the substantially entire sound absorption cover 60b.

Besides, as illustrated in FIG. 3 or 4, the sound absorption cover 60b is opposite to the communication ports 45, from the front wall 63. Thus, the noises which enter into the sound absorption cover 60b, as described above, is incident so as to collide with the front wall 63 of the sound absorption cover 60b, and is absorbed by the front wall 63.

Thus, the noises which enter into the sound absorption cover 60b is absorbed by the substantially entire sound absorption cover 60b is incident so as to collide with the front wall 63 of the sound absorption cover 60b, as described above, and is absorbed and attenuated favorably. This means that the sound absorption cover 60b having the above construction exhibits considerably favorable sound absorption ability, that is, attenuation ability with regard to the noises which enter into the inside thereof.

As a result, the noises from the outside of the motor vehicle hardly enter into the space passage between the outer plate 11 and the inner plate 12 of the vehicle body 10. This means that, when each of the left and right air exhaust valves V exhausts the air stream inside the vehicle body 10 from the motor vehicle, the intrusion of the noises from the outside of the motor vehicle into the inside of the vehicle compartment of the vehicle body 10 are shielded favorably by each of the left and right air exhaust valves V.

As described above, even when air inside the vehicle body 10 causes pressure in the inside of the vehicle body 10 at closing the door, as described above, the air having the pressure is favorably exhausted as an air stream from the motor vehicle by each of the left and right air exhaust valves V at good timing, as described above, so that the door can be easily closed. Besides, the cover member 60 having the above construction is disposed to each of the left and right air exhaust valves V, so that, when each of the left and right air exhaust valves V exhausts the air stream, noises which enter from the outside of the motor vehicle into each of the left and right air exhaust valves V is absorbed and attenuated favorably by the sound absorption cover 60b of each of the left and right air exhaust valves V. As a result, the passenger in the vehicle compartment is not given an uncomfortable feeling from noises which pass through at least one of the left and right air exhaust valves V and is likely to enter into the vehicle compartment.

Comparisons were made on air exhaustion ability and sound absorption ability of the right air exhaust valve V of the left and right air exhaust valves V in the first embodiment, as an example, and first and second comparative examples.

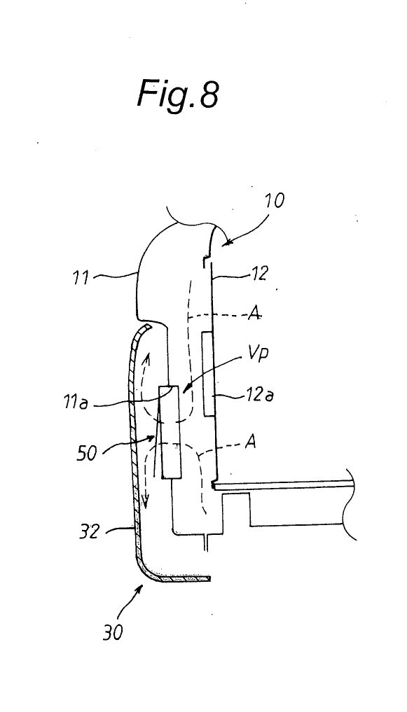

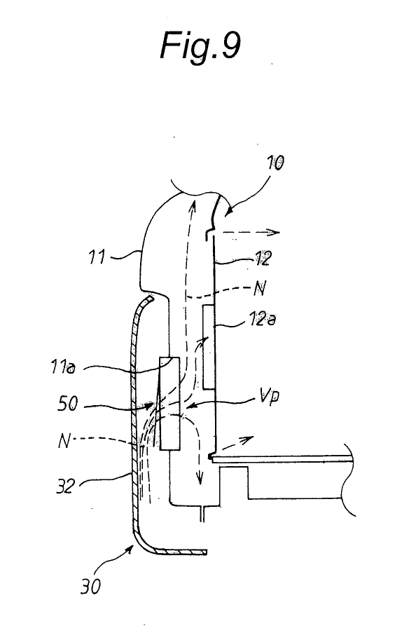

In the comparative examples, the conventional air exhaust valve Vp (see FIGS. 8 and 9) is adopted, and like the example, the air exhaust valve Vp is mounted on the rear portion on the right side of the vehicle body 10 (see FIGS. 8 and 9). In the air exhaust valve Vp, the cover member 60 is removed from the right air exhaust valve V. Like FIGS. 6 and 7, the left side in FIGS. 8 and 9 corresponds to the left side of the vehicle body 10.

Note that, in the first comparative example, a sound absorption material 12a illustrated in FIGS. 8 and 9 is not adopted. Thus, no sound absorption material is disposed in each portion of the outer plate 11 and the inner plate 12 in the rear portion on the right side of the vehicle body 10.

Unlike the first comparative example, in the second comparative example, as illustrated in FIGS. 8 and 9, the sound absorption material 12a is stuck onto the face of the inner plate 12 opposite to the outer plate 11 near the air exhaust valve Vp.

Thus, in both the first and second comparative examples, when air inside the vehicle body 10, which causes air pressure at closing the door, flows as an air stream in the space passage of the vehicle body 10, like the plate-shaped valve element 50 of the example (the right air exhaust valve V), the conventional air exhaust valve Vp swings to the outside of the motor vehicle at the plated-shaped valve element 50, and exhausts the air stream from the space passage from the motor vehicle (see FIG. 8).

In the process in which the air stream inside the vehicle compartment of the vehicle body 10 is exhausted from the motor vehicle by the air exhaust valve Vp, the air exhaust valve Vp swings at the plate-shaped valve element 50 to the outside the motor vehicle, thereby opening the annular valve seat portion.

In such a state, when noises enter from the outside of the vehicle body 10 into the air exhaust valve Vp through the plate-shaped valve element 50, the noises further enter into the space passage (see each arrow indicated by reference sign N in FIG. 9).

In the first comparative example, the right sound absorption member 60 in the example and the sound absorption material 12a in the second comparative example are not disposed in the space passage. Thus, the noises which enter into the space passage as described above is not absorbed, and enter into the vehicle body 10, thereby giving an uncomfortable feeling to the passenger in the vehicle compartment.

In the second comparative example, the sound absorption material 12a is stuck onto the portion of the inner plate 12 near the air exhaust valve Vp as described above, but, like the first comparative example, the second comparative example does not have the sound absorption member 60 of the example.

Thus, the noises, which enter into the air exhaust valve Vp as described above, is not absorbed by the air exhaust valve Vp, enter into the space passage, and is absorbed by the sound absorption material 12a.

However, since the sound absorption material 12a is merely stuck along the face of the inner plate 12 opposite to the outer plate 11 as described above, the noises which enter into the space passage simply flows along the sound absorption material 12a as described above. Thus, the noises are not absorbed favorably by the sound absorption material 12a, and enter into the inside of the vehicle body 10, thereby giving an uncomfortable feeling to the passenger in the vehicle compartment.

Unlike the first and second comparative examples, the example has the right sound absorption member 60 having the above construction, and achieves the sound absorption effect, as described above, which is not achieved in the first and second comparative examples.

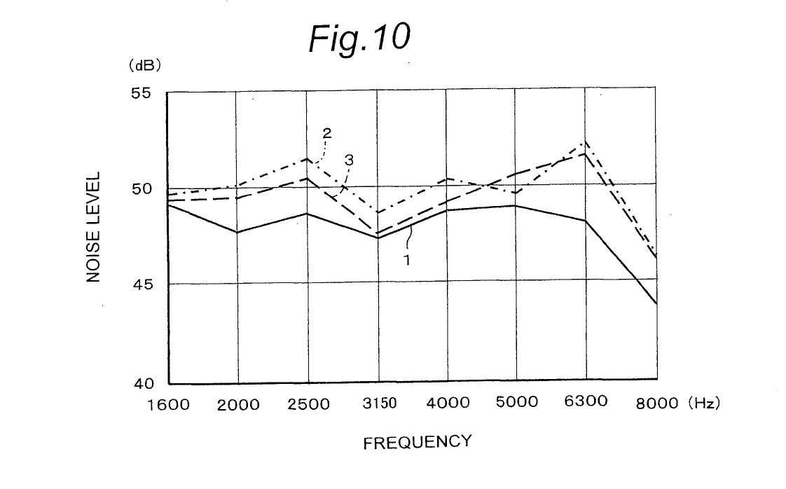

The noise levels of the example and the first and second comparative examples were measured relative to the frequencies, and graphs 1 to 3 were obtained as illustrated in FIG. 10. The noise levels correspond to the attenuation degrees of the example and the first and second comparative examples with regard to noises from the outside of the motor vehicle.

Graph 1 shows the characteristic of the example in accordance with the relation between the noise levels and the frequencies. Graph 2 shows the characteristic of the first comparative example in accordance with the relation between the noise levels and the frequencies. Graph 3 shows the characteristic of the second comparative example in accordance with the relation between the noise levels and the frequencies.

Comparing the graphs with one another, the example is lower in noise level than the first and second comparative examples over all the frequencies. Thus, the example has more favorable sound attenuation ability, that is, more favorable sound absorption ability as compared with the first and second comparative examples.

The same things may hold true even when the left air exhaust valve V is adopted, as the example, in place of the right air exhaust valve V.

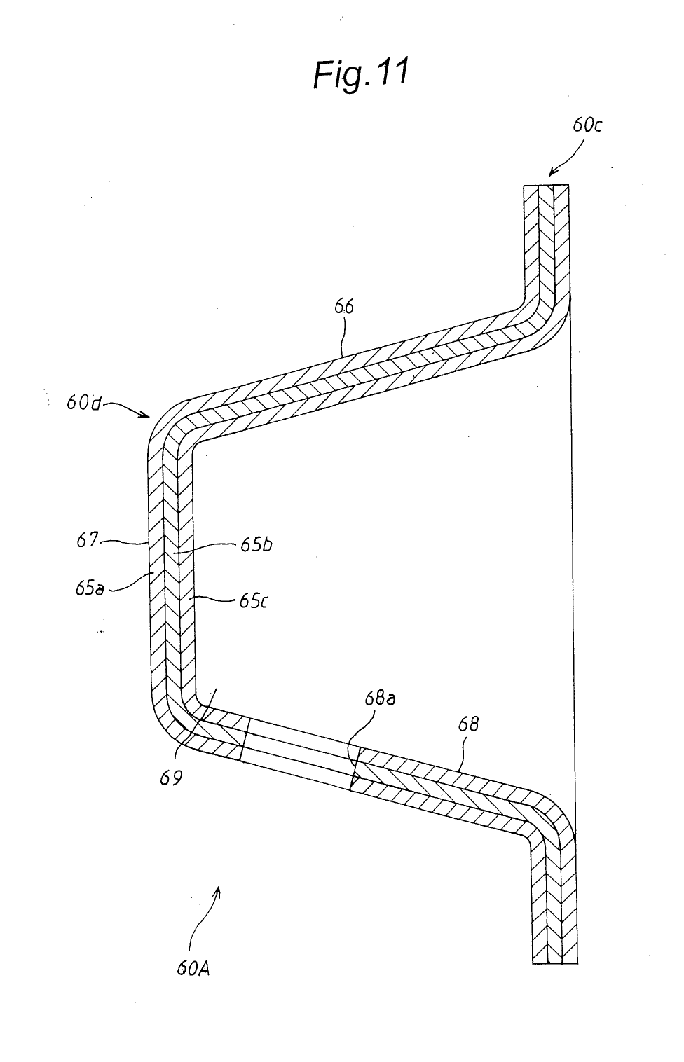

FIG. 11 illustrates major parts in a second embodiment of the present invention. In the second embodiment, the right air exhaust valve V of the left and right air exhaust valves V described in the first embodiment has a cover member 60A, in place of the cover member 60.

As illustrated in FIG. 11, the cover member 60A has a three-layer structure of a first fusion film 65a, a barrier film 65b, and a second fusion film 65c.

In the second embodiment, the first fusion film 65a is made of a predetermined thermoplastic material for first fusion films at a predetermined thickness (e.g., 20 (W). The barrier film 65b is made of a predetermined thermoplastic material for barrier films at a predetermined thickness (e.g., 15 (μm)). The second fusion film 65c is made of a material equal to that for the first fusion film 65a at a predetermined thickness equal to that of the first fusion film 65a.

As the predetermined thermoplastic material for first fusion films, which forms the first fusion film 65a and the second fusion film 65c, polyethylene is adopted. As the predetermined thermoplastic material for barrier films, which forms the barrier film 65b, nylon is adopted. The reason why, as the predetermined thermoplastic material for the barrier film, nylon is adopted is that nylon is higher in melting point than polyethylene which is the material for the first fusion film 65a and the second fusion film 65c.

The cover member 60A is formed by fusion bonding the first fusion film 65a and the second fusion film 65c onto both sides of the barrier film 65b, and has the cross-section shape illustrated in FIG. 11. In the fusion bonding, since the melting point of nylon forming the barrier film 65b is higher than the melting point of polyethylene forming the first fusion film 65a and the second fusion film 65c, as described above, the heating temperature required for the fusion bonding is set to be lower than the melting point of nylon and to be higher than the melting point of polyethylene. Thus, the first fusion film 65a and the second fusion film 65c can be bonded by fusion onto both sides of the barrier film 65b without melting the barrier film 65b.

As illustrated in FIG. 11, the cover member 60A having the three-layer structure has an annular peripheral wall 60c fitted into the mounting frame 70a of the left mounting member 70 described in the first embodiment, and a sound absorption and shield cover 60d, and is formed in the cross-section shape illustrated in FIG. 11.

The sound absorption and shield cover 60d having the three-layer structure bulges, in a U-shaped cross section, from the inner peripheral end portion of the annular peripheral wall 60c to the front side (or to the inside of the motor vehicle). Thus, the sound absorption and shield cover 60d has an upper wall 66, a front wall 67, and a lower wall 68 (corresponding to the upper wall 62, the front wall 63, and the lower wall 64 of the sound absorption cover 60b described in the first embodiment), and is formed in a U-shaped lateral cross section together with left and right walls 69 (FIG. 11 illustrates only the right wall 69) corresponding to the left and right walls 65 of the sound absorption cover 60b described in the first embodiment.

As illustrated in FIG. 11, the sound absorption and shield cover 60d having the three-layer structure has an opening portion 68a (hereinafter, also called a lower opening portion 68a). Like the lower opening portion 64a of the sound absorption cover 60b described in the first embodiment, the lower opening portion 68a communicates the communication ports 45 of the partition mechanism 40b described in the first embodiment with the lower side of the lower wall 68 (corresponding to the lower wall 64 in the first embodiment).

As described above, the cover member 60A constructed in this manner has the three-layer structure including the first fusion film 65a, the barrier film 65b, and the second fusion film 65c. Thus, the cover member 60A is formed very thinly. Besides, the first fusion film 65a, the barrier film 65b, and the second fusion film 65c have non-air permeability. This means that the cover member 60A has non-air permeability.

The thin cover member 60A exhibits favorable sound absorption ability. The non-air permeable cover member 60A exhibits favorable sound shield ability. This means that the cover member 60A has sound absorption and shield ability.

The left air exhaust valve V described in the first embodiment has the cover member 60A which is equal in construction and function to the cover member 60A of the right air exhaust valve V in the second embodiment, in place of the sound absorption member 60. Other constructions are similar to those in the first embodiment.

Like the first embodiment, in the second embodiment constructed in this manner, when an air stream is exhausted by each of the left and right air exhaust valves V from the inside of the vehicle compartment of the vehicle body 10 to the outside of the motor vehicle, noises from the outside of the vehicle body 10 enter from between each of the left and right plate-shaped valve elements 50 and the corresponding valve seat portion wall 41 into the second fusion film 65c of each of the left and right cover members 60A through the hollow portion of the corresponding valve seat portion wall 41, the corresponding annular valve seat portion Vs, and the communication ports 45.

As described above, each of the left and right cover members 60A is formed of the three-layer structure. Besides, the second fusion film 65c, the barrier film 65b, and the first fusion film 65a, which form the three-layer structure, are very thin and have non-air permeability. Thus, as described above, each of the left and right cover members 60A has sound absorption and shield ability. This means that each of the left and right cover members 60A is a sound absorption and shield cover member.

When the noises enter into the second fusion film 65c of each of the left and right cover members 60A, the noises are incident onto the front wall 67 from the second fusion film 65c of each of the left and right cover members 60A.

With this, according to the sound shield ability, the noises which are incident on the front wall 67 is subsequently shielded and attenuated by the film portions of the second fusion film 65c, the barrier film 65b, and the first fusion film 65a corresponding to the front wall 67 from the film portion of the second fusion film 65c to the film portion of the first fusion film 65a.

In addition, according to the sound absorption ability, the noises which are not shielded by the film portions of the second fusion film 65c, the barrier film 65b, and the first fusion film 65a is absorbed and attenuated by the film portions of the second fusion film 65c, the barrier film 65b, and the first fusion film 65a.

Of the noises which enter into each of the left and right cover members 60A, as described above, the noises which are incident on the portion of each of the left and right cover members 60A except for each front wall 67 flows toward the front wall 67 while being shielded or absorbed by the portion of each of the left and right cover members 60A except for each front wall 67, and is shielded, absorbed, and attenuated by the front wall 67 as described above.

As a result, the noises are absorbed, shielded, and attenuated more favorably by the three-layer structure of each of the left and right cover members 60A. Other operations and effects are similar to those in the first embodiment.

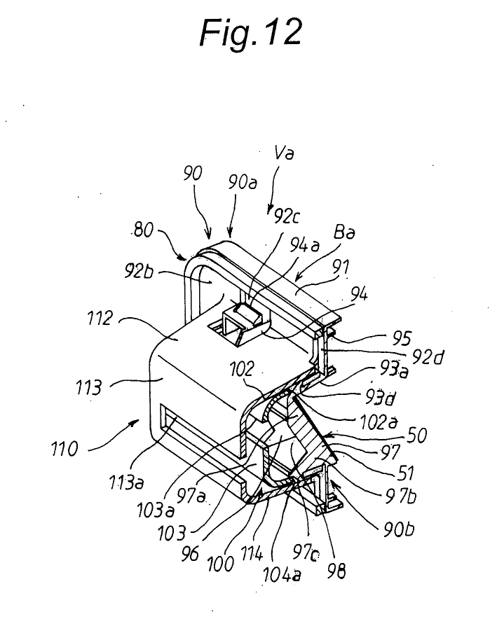

FIG. 12 illustrates a right air exhaust valve Va of left and right air exhaust valves Va, which is the major part in a third embodiment of the present invention. In the third embodiment, in place of the left and right air exhaust valves V described in the first embodiment, the left and right air exhaust valves Va are mounted on the rear portions on the left and right sides of a vehicle body 10a of the motor vehicle.

FIG. 12 is a perspective view of the right half portion of the right air exhaust valve Va. The right air exhaust valve Va has, as a whole, the right half portion and the left half portion. The right half portion and the left half portion of the right air exhaust valve Va are symmetric in the widthwise direction with respect to the center line in the widthwise direction of the right air exhaust valve Va.

The right air exhaust valve Va has a valve seat member 90, and cover members 100, 110, in place of the valve seat member 40, the cover member 60, and the mounting member 70 of the right air exhaust valve V described in the first embodiment. Here, in the right air exhaust valve Va, the plate-shaped valve element 50, the valve seat member 90, and the gasket 80 are called a valve body Ba (see FIG. 12). The valve seat member 90 and the cover members 100, 110 are, hereinafter, also called a right valve seat member 90 and right cover members 100, 110, respectively.

The right valve seat member 90 corresponds to the valve seat member 40 and the mounting member 70 of the right air exhaust valve V described in the first embodiment. The right valve seat member 90 serves both as the valve seat member 40 and the mounting member 70 described in the first embodiment.

As illustrated in any one of FIGS. 12 to 14, the right valve seat member 90 forms the valve portion of the right air exhaust valve Va by an annular valve seat portion Vsa (described later) formed in the right valve seat member 90 and the right plate-shaped valve element 50 described in the first embodiment.

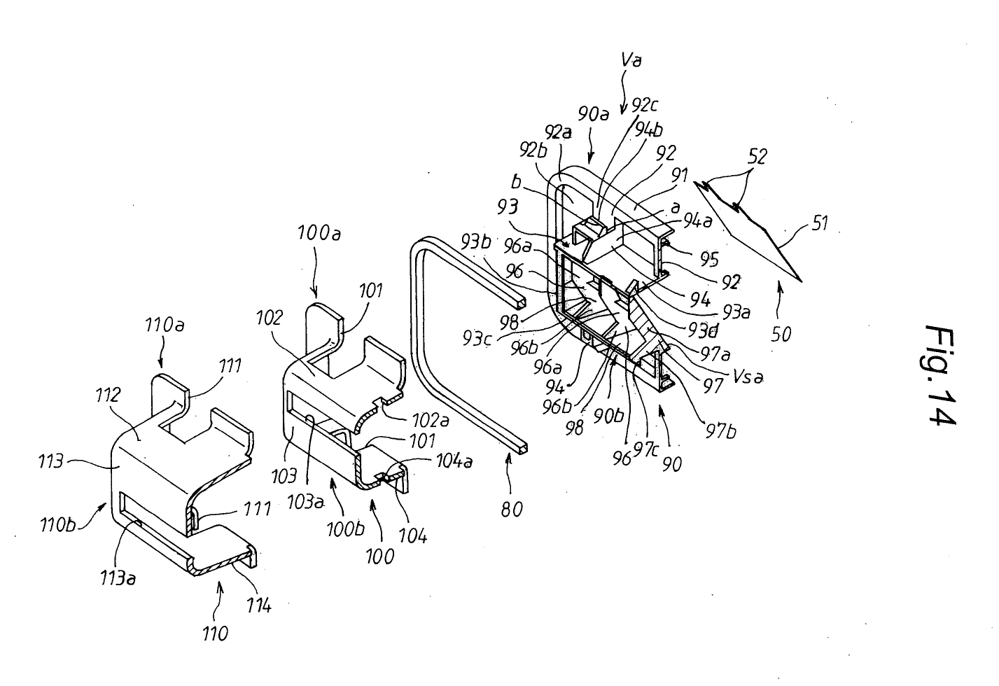

As illustrated in FIG. 14, the right valve seat member has an outer peripheral frame 90a, and a partition mechanism 90b. The right valve seat member 90 is made of a synthetic resin material (e.g., polypropylene). The outer peripheral frame 90a has an annular peripheral wall 91, a valve seat portion wall 92, and a tubular body 93. The annular peripheral wall 91 extends from the outer peripheral end portion of the valve seat portion wall 92, to the rear side (or to the outside of the motor vehicle), and is bent in an L shape.

As illustrated in FIG. 14, the valve seat portion wall 92 has an annular outer peripheral wall 92a, and a thin wall 92b. The thin wall 92b is thinly formed in the inside of the annular outer peripheral wall 92a of the valve seat portion wall 92, so as to be integral with the rear end portion of the annular outer peripheral wall 92a (or the end portion in the inside of the motor vehicle), except for left and right intermediate walls 92c (FIG. 14 illustrates only the right intermediate wall 92c) and a center wall 92d.

As seen from FIG. 14, the tubular body 93 extends in a square tubular shape from the inner peripheral end portion of the hollow portion of the valve seat portion wall 92 to the front side. The tubular body 93 has an upper wall 93a, left and right walls 93b (FIG. 14 illustrates only the right wall 93b), and a lower wall 93c.

The upper wall 93a extends from the upper end portion of the peripheral end portion of the hollow portion of the valve seat portion wall 92 to the front side. The left and right walls 93b extend downward from the left and right ends of the upper wall 93a. The lower wall 93c extends from the lower end portion of the peripheral end portion of the hollow portion of the valve seat portion wall 92 to the front side. The upper wall 93a also extends from the upper end portion of the inner peripheral end portion of the hollow portion of the valve seat portion wall 92 to the rear side. In FIG. 14, reference sign 95 denotes an inner annular wall.

The outer peripheral frame 90a has two pairs of engaging claw members 94 (FIG. 14 illustrates only a pair of right engaging claw members 94). As illustrated in FIG. 14, of the two pairs of upper and lower engaging claw members 94, the pair of right upper and lower engaging claw members 94 extend from the upper and lower intermediate portions of the right intermediate wall 92c of the valve seat portion wall 92 to the front side.

Of the pair of right upper and lower engaging claw members 94, the right upper engaging claw member 94 extends from the upper intermediate portion of the right intermediate wall 92c of the valve seat portion wall 92 to the front side. The right upper engaging claw member 94 has an inverted U-shaped lateral cross section base 94a and an engaging claw 94b.

The base 94a is seated, at both legs thereof, on the upper face of the tubular body 93. The engaging claw 94b has a substantially right-angled triangle of lateral cross section, and projects upward from the upper face of the base 94a. The engaging claw 94b extends upward from the upper face of the base 94a so as to be, at a rear wall a, perpendicular to the upper face of the tubular body 93.

The engaging claw 94b extends, at an inclined face b, to the upper face of the base 94a so as to be inclined from the extending end of the rear wall of the engaging claw 94b toward the front lower side. Thus, the upper engaging claw member 94 can engage, at the engaging claw 94b, into the upper end portion of the inner periphery of the mounting bore 11a of the outer plate 11 of the vehicle body 10 described in the first embodiment from the lower side thereof.

Of the pair of right upper and lower engaging claw members 94, the right lower engaging claw member 94 is equal in construction to the right upper engaging claw member 94. The right lower engaging claw member 94 extends from the lower intermediate portion of the right intermediate wall 92c of the valve seat portion wall 92 to the front side, so that the right lower engaging claw member 94 and the right upper engaging claw member 94 are symmetric.

A pair of left upper and lower engaging claw members 94 are equal in construction to the pair of right upper and lower engaging claw members 94. The pair of left upper and lower engaging claw members 94 extend from the upper and lower intermediate portions of the left intermediate wall 92c of the valve seat portion wall 92 to the front side.

The partition mechanism 90b is disposed in the tubular body 93. The partition mechanism 90b has a plurality of section walls 96, and a center section wall 97 positioning the plurality of section walls 96 on the left and right sides.

Each of the plurality of section walls 96 integrally has an inclined wall 96a, and a leg 96b. The plurality of section walls 96 are aligned on the left and right sides of the center section wall 97, and are spaced from each other in the widthwise direction.

In the plurality of section walls 96, the inclined walls 96a are integrally formed, at the upper ends thereof, with the extending end of the upper wall 93a of the tubular body 93 so as to be spaced from each other, and the inclined walls 96a are integrally formed, at the lower ends thereof, with the lower end portion of the inner peripheral end portion of the hollow portion of the valve seat portion wall 92 so as to be spaced from each other.

Each leg 96b extends integrally from the lower end of the corresponding inclined wall 96a to the front side. The leg 96b is seated, at the lower end portion thereof, on a lower wall 104 (described later) of the right cover member 100.

The center section wall 97 integrally has an inclined wall 97a and a leg 97b, and is positioned at the center in the widthwise direction of the hollow portion of the tubular body 93. In the center section wall 97, the inclined wall 97a is integrally formed, at the upper end thereof, with the center in the widthwise direction of the extending end of the upper wall 93a of the tubular body 93, and is integrally formed, at the lower end thereof, with the center in the widthwise direction of the lower end portion of the inner peripheral end portion of the hollow portion of the valve seat portion wall 92.

As described above, the section walls 96, 97 section the hollow portion of the tubular body 93 so as to be spaced from each other in the widthwise direction. This means that the section walls 96, 97 section the annular valve seat portion Vsa, that is, the hollow portion of the valve seat portion wall 92 into a plurality of ventilation holes 98.

The leg 97b extends integrally from the lower end of the inclined wall 97a to the front side. The leg 97b is seated at the lower end portion thereof on the lower wall 104 (described later) of the cover member 100.

The right cover members 100, 110 correspond to the cover member 60 described in the first embodiment. The right cover members 100, 110 are mounted on the valve seat member 90 from the front side. In the third embodiment, as the material for the right cover members 100, 110, the fiber sound absorption material described in the first embodiment is adopted.

In the right valve seat member 90, the plurality of pairs of engaging claw members 94 are fitted into the right mounting bore 11a of the outer plate 11 of the vehicle body described in the first embodiment. When the right valve seat member 90 is contacted, at the annular outer peripheral wall 92a of the outer peripheral frame 90a, onto the outer periphery of the right mounting bore 11a via the right gasket 80, the claws 94b of the plurality of pairs of engaging claw members 94 engage into the plurality of pairs of concave cutaway portions of the right mounting bore 11a against the resilient force thereof.

Thus, the right valve seat member 90 is mounted on the outer plate portion of the rear portion of the right outer plate 11 of the vehicle body 10 in air-tight and liquid-tight manner via the right gasket 80. The right gasket 80 is interposed between the outer plate portion of the rear portion of the right outer plate 11 of the vehicle body 10 and the annular outer peripheral wall 92a of the outer peripheral frame 90a.

As illustrated in FIG. 14, the right cover member 100 has an annular peripheral wall 100a fitted into the valve seat portion wall 92 of the outer peripheral frame 90a from the front side, and a sound absorption cover 100b. The right cover member 100 is integrally made of the fiber sound absorption material described in the first embodiment in a wall shape.

The annular peripheral wall 100a is integral with the sound absorption cover 100b, and has a plurality of pairs of upper and lower cutaway portions 101 (FIG. 14 illustrates only a pair of upper and lower cutaway portions 101).

Of the plurality of pairs of upper and lower cutaway portions 101, the pair of right upper and lower cutaway portions 101 correspond to the right intermediate wall 92c of the valve seat portion wall 92. Of the pair of right upper and lower cutaway portions 101, the right upper cutaway portion 101 is formed over the right upper end portion intermediate portion of the annular peripheral wall 100a corresponding to the upper portion of the right intermediate wall 92c of the valve seat portion wall 92 and an upper wall 102 (described later) of the sound absorption cover 100b.

Specifically, the right upper cutaway portion 101 is cut away from the outer end portion of the right upper end intermediate portion of the annular peripheral wall 100a to the right intermediate portion of the upper wall 102 of the sound absorption cover 100b.

Thus, the right upper engaging claw member 94 and the upper portion of the right intermediate wall 92c of the valve seat portion wall 92 are fitted into the right upper cutaway portion 101. With this, the right upper end portion of the annular peripheral wall 100a is contacted, at the outer face thereof, onto the thin wall 92b from the front side.

The right lower cutaway portion 101 is formed over the right lower end intermediate portion of the annular peripheral wall 100a corresponding to the lower portion of the right intermediate wall 92c of the valve seat portion wall 92 and the lower wall 104 (described later) of the sound absorption cover 100b. Specifically, the right lower cutaway portion 101 is cut away from the outer edge of the right lower end intermediate portion of the annular peripheral wall 100a to the intermediate portion of the lower wall 104 of the sound absorption cover 100b.

Thus, the right lower engaging claw member 94 and the lower portion of the right intermediate wall 92c of the valve seat portion wall 92 are fitted into the right lower cutaway portion 101. With this, the right lower end portion of the annular peripheral wall 100a is contacted, at the outer face thereof, onto the thin wall 92b from the front side.

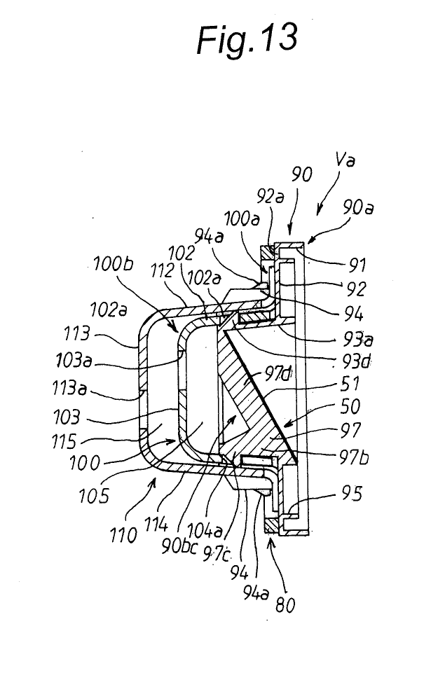

The sound absorption cover 100b bulges, in a U-shaped cross section, from the hollow portion of the annular peripheral wall 100a to the front side (or to the inside of the motor vehicle). The sound absorption cover 100b has the upper wall 102, a front wall 103, the lower wall 104, and left and right walls 105 (FIG. 13 illustrates only the right wall 105), and is formed in a U-shaped cross section.

The upper wall 102 extends integrally from the upper end portion of the hollow portion of the annular peripheral wall 100a to the front side (or to the inside of the motor vehicle). The upper wall 102 has an engaging hole 102a. A claw 93d which projects upward from the front end of the upper wall 93a of the tubular body 93 engages into the engaging hole 102a (see FIG. 13).

The front wall 103 extends downward from the extending end of the upper wall 102, is bent in an L shape, and is opposite to the opening portion of the tubular body 93, that is, the hollow portion of the annular peripheral wall 100a. The front wall 103 has an opening portion 103a (hereinafter, also called a front opening portion 103a). The front opening portion 103a is opened, in a rectangular shape, in the upper intermediate portion of the front wall 103 so as to be opposite to the ventilation holes 98 of the partition mechanism 90b. Thus, the front opening portion 103a communicates the ventilation holes 98 of the partition mechanism 90b with the front space of the front wall 103 (or with the space between the front wall 103 and a front wall 113 (described later)).

The lower wall 104 extends from the extending end of the front wall 103 to the rear side (or to the outside of the motor vehicle), and is bent in an L shape. The lower wall 104 has an extending end integrally formed with the lower end portion of the hollow portion of the annular peripheral wall 100a. The lower wall 104 has an engaging hole 104a. A claw 97c which projects downward from the end of the leg 97b of the center section wall 97 of the partition mechanism 90b engages into the engaging hole 104a (see FIG. 13).

The left and right walls 105 are formed integrally with the upper wall 102, the front wall 103, and the lower wall 104, from the left and right sides thereof (see FIG. 13). Thus, the sound absorption cover 100b is closed except for the front and rear sides thereof.

As illustrated in FIG. 14, the right cover member 110 has an annular peripheral wall 110a fitted into the valve seat portion wall 92 of the outer peripheral frame 90a from the front side via the annular peripheral wall 100a, and a sound absorption cover 110b. The right cover member 110 is integrally made of the fiber sound absorption material described in the first embodiment in a wall shape.

The annular peripheral wall 110a is integral with the sound absorption cover 110b, and has a plurality of pairs of upper and lower cutaway portions 111 (FIG. 14 illustrates only a pair of right upper and lower cutaway portions 111).

Of the plurality of pairs of upper and lower cutaway portions 111, the pair of right upper and lower cutaway portions 111 correspond to the right intermediate wall 92c of the valve seat portion wall 92 through the pair of right upper and lower cutaway portions 101 of the sound absorption cover 100. Of the pair of right upper and lower cutaway portions 111, the right upper cutaway portion 111 is formed over the right upper end intermediate portion of the annular peripheral wall 110a corresponding to the upper portion of the right intermediate wall 92c of the valve seat portion wall 92 and an upper wall 112 (described later) of the sound absorption cover 110b.

Specifically, the right upper cutaway portion 111 is cut away from the outer end portion of the right upper end intermediate portion of the annular peripheral wall 110a to the intermediate portion of the upper wall 112 of the sound absorption cover 110b.

Thus, the right upper engaging claw member 94 and the upper portion of the right intermediate wall 92c of the valve seat portion wall 92 are fitted into the right upper cutaway portion 111 through the right upper cutaway portion 101 of the sound absorption cover 100. With this, the right upper end portion of the annular peripheral wall 110a is contacted, at the outer face thereof, onto the thin wall 92b from the front side via the right upper end portion of the annular peripheral wall 100a.

The right lower cutaway portion 111 is formed over the right lower end intermediate portion of the annular peripheral wall 110a corresponding to the lower portion of the right intermediate wall 92c of the valve seat portion wall 92 and a lower wall 114 (described later) of the sound absorption cover 110b.

Specifically, the right lower cutaway portion 111 is cut away from the outer end portion of the right lower end intermediate portion of the annular peripheral wall 110a to the intermediate portion of the lower wall 114 of the sound absorption cover 110b.

Thus, the right lower engaging claw member 94 and the lower portion of the right intermediate wall 92c of the valve seat portion wall 92 are fitted into the right lower cutaway portion 111 through the right lower cutaway portion 101 of the sound absorption cover 100. With this, the right lower end portion of the annular peripheral wall 110a is contacted, at the outer face thereof, onto the thin wall 92b from the front side via the right lower end portion of the annular peripheral wall 100a.

The sound absorption cover 110b bulges, in a U-shaped cross section, from the hollow portion of the annular peripheral wall 110a to the front side (or to the inside of the motor vehicle). The sound absorption cover 110b has the upper wall 112, the front wall 113, the lower wall 114, and left and right walls 115 (FIG. 13 illustrates only the right wall 115), and is formed in a U-shaped cross section.

The upper wall 112 extends integrally from the upper end portion of the hollow portion of the annular peripheral wall 110a to the front side (or to the inside of the motor vehicle). The front wall 113 extends downward from the extending end of the upper wall 112, is bent in an L shape, and is opposite to the hollow portion of the annular peripheral wall 110a. The front wall 113 has an opening portion 113a (hereinafter, also called a front opening portion 113a). The opening portion 113a is opened, in a rectangular shape, in the lower intermediate portion of the front wall 113 below the front opening portion 103a of the front wall 103. Thus, the front opening portion 113a is opposite to the front wall 103 of the sound absorption cover 100b below the front opening portion 103a.

The lower wall 114 extends from the extending end of the front wall 113 to the rear side (or to the outside of the motor vehicle), and is bent in an L shape. The lower wall 114 has an extending end integrally formed with the lower end portion of the hollow portion of the annular peripheral wall 110a. The left and right walls 115 are formed integrally with the upper wall 112, the front wall 113, and the lower wall 114 from the left and right sides thereof (see FIG. 13). Thus, the sound absorption cover 110b is closed except for the front and rear sides thereof.

The left air exhaust valve Va is equal in construction to the right air exhaust valve Va. Thus, the left air exhaust valve Va has the valve seat member 90, and the cover members 100, 110, in place of the valve seat member 40, the cover member 60, and the mounting member 70 of the left air exhaust valve V described in the first embodiment.

This means that the left air exhaust valve Va has a left valve seat member 90 and left cover members 100, 110, which are equal in construction to the valve seat member 90 and the cover members 100, 110 of the right air exhaust valve Va, and the left plate-shaped valve element 50 and the left gasket 80 described in the first embodiment.

The left valve seat member 90, the left cover members 100, 110, the left plate-shaped valve element 50, and the left gasket 80 are equal in mounting construction to the valve seat member 90, the cover members 100, 110, the plate-shaped valve element 50, and the gasket 80 of the right air exhaust valve Va. Thus, the mounting construction of the left air exhaust valve Va is equal to the mounting construction of the right air exhaust valve Va.

In the left air exhaust valve Va mounted in this manner, in the left valve seat member 90, the plurality of pairs of engaging claw members 94 are fitted into the left mounting bore 11a of the outer plate 11 of the vehicle body 10 described in the first embodiment. When the left valve seat member 90 is contacted onto the outer periphery of the left mounting bore 11a via the left gasket 80 at the annular outer peripheral wall 92a of the outer peripheral frame 90a, the claws 94b of the plurality of pairs of engaging claw members 94 engage into the plurality of pairs of concave cutaway portions of the left mounting bore 11a against the resilient force thereof.

Thus, the left valve seat member 90 is mounted on the outer plate portion of the rear portion on the left outer plate 11 of the vehicle body 10 in air-tight and liquid-tight manner via the left gasket 80. The left gasket 80 is interposed between the outer plate portion of the rear portion on the left outer plate 11 of the vehicle body 10 and the annular outer peripheral wall 92a of the outer peripheral frame 90a. In the third embodiment, the passage from the valve seat portion Vsa to the opening portion 113a of the cover member 110 is also called an airflow passage for an air stream. Other constructions in the third embodiment are similar to those in the first embodiment.

In the third embodiment constructed as above, like each of the left and right air exhaust valves V described in the first embodiment, the left and right air exhaust valves Va are mounted on the rear portions on the left and right sides of the vehicle body 10 of the motor vehicle. In such a mounted state, in the left air exhaust valve Va, the left valve seat member 90 is fitted, at the plurality of pairs of engaging claw members 94, into the left mounting bore 11a of the outer plate 11 of the vehicle body 10 described in the first embodiment via the left gasket 80. In the right air exhaust valve Va, the right valve seat member 90 is fitted, at the plurality of pairs of engaging claw members 94, into the right mounting bore 11a of the outer plate 11 of the vehicle body 10 described in the first embodiment via the right gasket 80.

With this, each of the left and right valve seat members 90 is contacted, at the annular outer peripheral wall 92a of the corresponding outer peripheral frame 90a, onto the outer periphery of each of the left and right mounting bores 11a via each of the left and right gaskets 80, and the claws 94b of the corresponding pairs of engaging claw members 94 engage into the corresponding pairs of concave cutaway portions of each of the left and right mounting bores 11a against the resilient force thereof. Thus, each of the left and right valve seat members 90 is mounted on the outer plate portion of the rear portion on each of the left and right outer plate 11 of the vehicle body 10 in air-tight and liquid-tight manner via each of the left and right gaskets 80.

In such a mounted state, the left cover member 110 passes, at the sound absorption cover 110b, through the left mounting bore 11a of the outer plate 11 of the vehicle body 10 together with the sound absorption cover 100b of the left cover member 100, and projects to between the outer plate 11 and the inner plate 12 of the vehicle body 10. The right cover member 110 passes, at the sound absorption cover 110b, through the right mounting bore 11a of the outer plate 11 of the vehicle body 10 together with the sound absorption cover 100b of the right cover member 100, and projects to between the outer plate 11 and the inner plate 12 of the vehicle body 10.

Thereby, in each of the left and right air exhaust valves Va, the sound absorption cover 110b is opened, at the front opening portion 113a, into the space passage between the outer plate 11 and the inner plate 12. In addition, the sound absorption cover 100b communicates, at the opening portion 103a with the space passage between the outer plate 11 and the inner plate 12 through the opening portion 113a of the sound absorption cover 110b.

The space passage between the outer plate 11 and the inner plate 12 communicates with the inside of the ventilation holes 98 of each valve seat member 90 through the front opening portion 113a of the sound absorption cover 110b and the front opening portion 103a of the sound absorption cover 100b of each of the left and right air exhaust valves Va. Each of the left and right plate-shaped valve elements 50 closes, at the valve element body 51, the annular valve seat portion Vsa, that is, the ventilation holes 98 of each of the left and right valve seat members 90. This means that each of the left and right air exhaust valves Va shields, at the valve portion thereof, the space passage between the outer plate 11 and the inner plate 12 of the vehicle body 10 of the motor vehicle from the outside of the vehicle body 10.

Each of the left and right valve seat members 90 is opposite to each of the left and right portions 32 of the rear bumper 30 from the inner face side thereof together with each of the left and right plate-shaped valve elements 50. Thus, each of the left and right air exhaust valves Va is not seen from the outside of the motor vehicle. Like each of the left and right air exhaust valves V described in the first embodiment, each of the left and right air exhaust valves Va does not deteriorate the appearance of the motor vehicle.

When the motor vehicle on which the left and right air exhaust valves Va are mounted, as described above, is driven and is then stopped, and the passenger opens the door of the vehicle body 10 of the motor vehicle, gets off, and closes the door, air inside the vehicle compartment of the vehicle body 10 causes pressure (air pressure) in the inside of the vehicle body 10 with the closing of the door, like the first embodiment.

Like the first embodiment, the air which causes the air pressure flows, as an air stream, into the space passage of the vehicle body 10, and then flows from each of the left and right mounting bores 11a of the outer plate 11 of the vehicle body 10 toward each of the left and right air exhaust valves Va.

In each of the left and right air exhaust valves Va, the air stream flows from the front opening portion 113a into the sound absorption cover 110b, and then flows through the front opening portion 103a of the sound absorption cover 100b above the front opening portion 113a toward the ventilation holes 98 of the valve seat member 90. Then, the air stream flows through the ventilation holes 98 and the annular valve seat portion Vsa of the valve seat member 90, and pushes the valve element body 51 of the plate-shaped valve element 50 to the rear side (or to the outside of the motor vehicle). With this, the plate-shaped valve element 50 swings, at the valve element body 51, to the rear side (or to the outside of the motor vehicle) relative to the connection portions 52, thereby opening the annular valve seat portion Vsa of the valve seat member 90.

Thus, as described above, in each of the left and right air exhaust valves Va, the air stream which flows through the ventilation holes 98 and the annular valve seat portion Vsa of the valve seat member 90 flows from between the valve element body 51 of the plate-shaped valve element 50 and the valve seat member 90 to the rear side. This means that the air stream from the inside of the vehicle compartment of the vehicle body 10 is exhausted to the outside of the motor vehicle by the air exhaust valve Va.

When each of the left and right air exhaust valves Va exhausts the air stream from the inside of the vehicle compartment of the vehicle body 10 to the outside of the motor vehicle, the plated-shaped valve element 50 of each of the left and right air exhaust valves Va swings to the outside of the motor vehicle, thereby opening each annular valve seat portion Vsa, that is, the ventilation holes 98 of the valve seat member 90.

In such a state, in each of the left and right air exhaust valves Va, noises from the outside of the vehicle body 10 enter from between the plate-shaped valve element 50 and the valve seat member 90 into the sound absorption cover 100b of the sound absorption member 100 through the annular valve seat portion Vsa and the ventilation holes 98 of the valve seat member 90.

In each of the left and right air exhaust valves Va, the sound absorption cover 100b is made of the fiber sound absorption material, and bulges, in a U-shaped cross section, from the hollow portion of the annular peripheral wall 100a to the front side. Thus, the sound absorption cover 100b covers, at the portion of the sound absorption cover 100b except for the front opening portion 103a, the opening portion of the tubular body 93, that is, the ventilation holes 98 and the annular valve seat portion Vsa, from the inside of the motor vehicle. The noises which enter into the sound absorption cover 100b, as described above, travels along the inner peripheral face of the sound absorption cover 100b, and is absorbed by the substantially entire sound absorption cover 100b.

In each of the left and right air exhaust valves Va, the sound absorption cover 100b which has, at the front wall 103, the front opening portion 103a, and, as illustrated in FIG. 12 or 13, the sound absorption cover 100b is opposite to the ventilation holes 98. Thus, the noises which enter into the sound absorption cover 100b, as described above, is incident so as to collide with the front wall 103 of the sound absorption cover 100b, and is absorbed by the front wall 103.

Thus, in each of the left and right air exhaust valves Va, while the noises which enter into the sound absorption cover 100b, as described above, is absorbed along the inner face of the sound absorption cover 100b, the noises are incident so as to collide with the front wall 103 of the sound absorption cover 100b, and is absorbed and attenuated favorably. This means that the sound absorption cover 100b having such a construction exhibits favorable sound absorption ability, with regard to the noises which enter into the inside thereof.

In each of the left and right air exhaust valves Va, as described above, the sound absorption cover 100b has, at the front wall 103, the front opening portion 103a. Thus, part of the noises, which enter into the sound absorption cover 100b, passes through the front opening portion 103a into the sound absorption cover 110b.

Like the sound absorption cover 100b, the sound absorption cover 110b is made of the fiber sound absorption material. In addition, on the front side of the sound absorption cover 100b, the sound absorption cover 110b bulges, in a U-shaped cross section, from the hollow portion of the annular peripheral wall 110a to the front side. Thus, the sound absorption cover 110b covers, at the portion of the sound absorption cover 110b except for the front opening portion 113a, the sound absorption cover 100b, from the front side (or from the inside of the motor vehicle). Thus, the noises which enter through the front opening portion 113a into the sound absorption cover 110b, as described above, is absorbed by the substantially entire sound absorption cover 110b.

In each of the left and right air exhaust valves Va, as illustrated in FIG. 13, the sound absorption cover 110b is opposite, at the front wall 113, to the front wall 103 of the sound absorption cover 100b from the front side, and the front opening portion 113a is formed in the front wall 113 in the position off and below the front opening portion 103a of the sound absorption cover 100b, so that the front opening portion 103a is opposite to the upper portion of the front opening portion 113a of the front wall 113.

Thus, the noises, which enter from the front opening portion 103a of the sound absorption cover 100b into the sound absorption cover 110b as described above, is incident so as to collide with the upper portion of the front opening portion 113a of the front wall 113 of the sound absorption cover 110b, and is absorbed by the front wall 113. Thus, the noises, which enter into the sound absorption cover 110b, is attenuated favorably by the sound absorption described above.

This means that, in each of the left and right air exhaust valves Va, the sound absorption cover 110b having the above construction exhibits favorable sound absorption ability with regard to the noises which enter into the inside thereof.

As a result, the noises from the outside of the motor vehicle do not enter into the space passage between the outer plate 11 and the inner plate 12 of the vehicle body 10. This means that, when each of the left and right air exhaust valves Va exhausts the air stream from the inside of the vehicle body 10 to the outside of the motor vehicle, the intrusion of the noises from the outside of the motor vehicle into the inside of the vehicle compartment of the vehicle body 10 are shielded favorably by each of the left and right air exhaust valves Va. In other words, each of the left and right air exhaust valves Va absorbs and attenuates the noises from the outside of the motor vehicle more favorably by the synergistic sound absorption ability of the sound absorption covers 100b, 110b.

As described above, even when air inside the vehicle body 10 causes pressure in the inside of the vehicle body 10 at closing the door, as described above, the air having the pressure is exhausted as an air stream favorably by each of the left and right air exhaust valves Va, as described above, so that the door can be easily closed. Besides, the cover members 100, 110 having the above construction are disposed to each of the left and right air exhaust valves Va, so that, in the process in which the air stream is exhausted by each of the left and right air exhaust valves Va, noises which enter from the outside of the motor vehicle into each of the left and right air exhaust valves Va is absorbed and attenuated favorably by the synergistic sound absorption ability of the sound absorption covers 100b, 110b of each of the left and right air exhaust valves Va. Thus, the passenger in the vehicle compartment is protected more favorably from an uncomfortable feeling caused by noises which are likely to enter through each of the left and right air exhaust valves Va into the vehicle compartment.

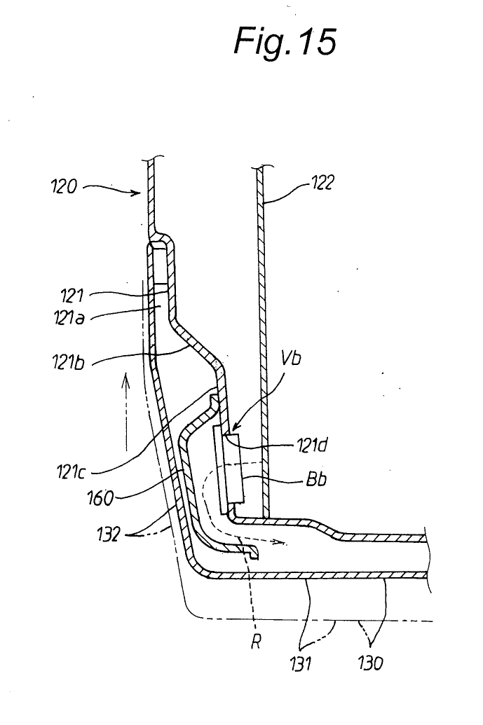

FIG. 15 illustrates major parts of another motor vehicle according to a fourth embodiment of the present invention. The motor vehicle has a vehicle body 120. The vehicle body 120 has a front bumper (not illustrated) at the front portion thereof (not illustrated), and a rear bumper 130 at the rear portion thereof.

Each of the left and right walls of the vehicle body 120 has an outer plate 121, and an inner plate 122. As illustrated in FIG. 15, the outer plate 121 as the left wall of the vehicle body 120 (hereinafter, also called a left outer plate 121) has, at the rear portion thereof, a front plate 121a, an intermediate inclined plate 121b, and a rear plate 121c, and is curved in a gentle crank shape.

The rear bumper 130 has a widthwise middle portion 131 supported along the rear portion of the vehicle body 120, and left and right portions 132 bent from the left and right ends of the widthwise middle portion 131 to the front side of the vehicle body 120 and extending along the rear portions on the left and right sides of the vehicle body 120. With this, the left portion 132 of the rear bumper 130 forms a space which can accommodate a left cover member 160 (described later) between the left portion 132 and the rear plate 121c of the left outer plate 121.

At the rear portion of the vehicle body 120, the right side wall of the vehicle body 120 and the left side wall of the vehicle body 120 are symmetric. With this, the right portion 132 of the rear bumper 130 forms a space which can accommodate a right cover member 160 (described later) between the right portion 132 and the rear plate 121c of the right outer plate 121 as the right side wall of the vehicle body 120.

The vehicle body 120 has left and right air exhaust valves Vb. The left and right air exhaust valves Vb are mounted on rear walls 123 of the rear portions on the left and right sides of the vehicle body 120.

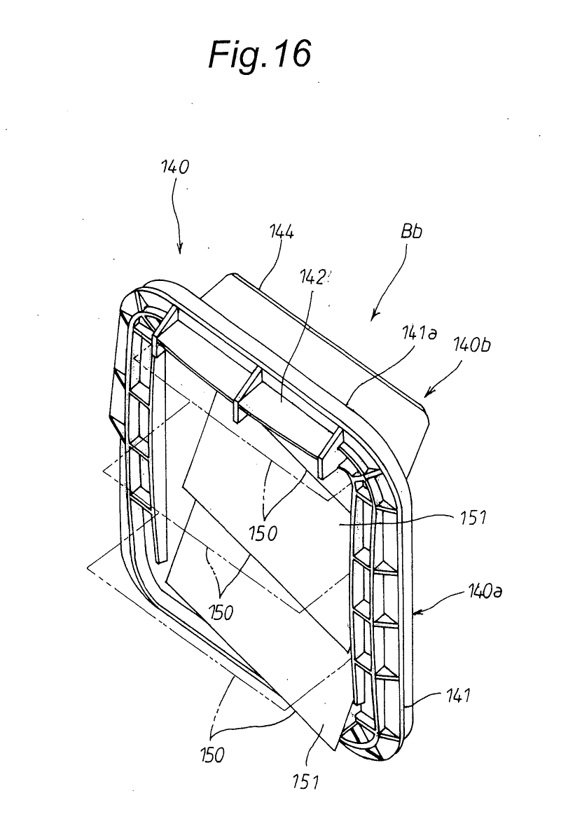

The construction of the left air exhaust valve Vb of the left and right air exhaust valves Vb will be described. As illustrated in any one of FIGS. 15 to 19, the left air exhaust valve Vb has a valve seat member 140, three plate-shaped valve elements 150, and the cover member 160. In the fourth embodiment, the valve seat member 140 and the three plate-shaped valve elements 150 are called a valve body Bb (see FIG. 16) of the left air exhaust valve Vb. In the left air exhaust valve Vb, the valve seat member 140, each plate-shaped valve element 150, and the cover member 160 are, hereinafter, also called a left valve seat member 140, a left plate-shaped valve element 150, and a left cover member 160, respectively. The three plate-shaped valve elements 150 are positioned on the upper, middle, and lower sides in FIG. 16, and are also called a left upper plate-shaped valve element 150, a left middle plate-shaped valve element 150, and a left lower plate-shaped valve element 150.

In the left air exhaust valve Vb, the left valve seat member 140 and the left cover member 160 are mounted mutually, via the rear plate 121c of the left outer plate 121 of the vehicle body 120 (see FIG. 15).

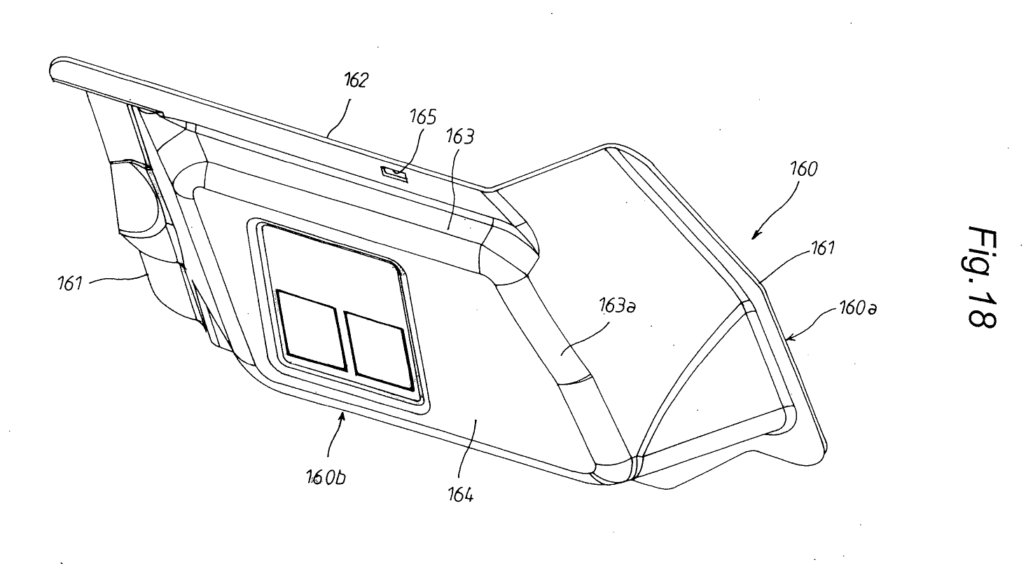

As illustrated in FIGS. 16 and 18, the left valve seat member 140 has a mounting frame 140a, and a valve seat portion body 140b. The mounting frame 140a has an annular peripheral wall 141, upper and lower walls 142 (FIGS. 16 and 18 illustrate only the upper wall 142), and an annular flange 143.

Of the upper and lower walls 142, the upper wall 142 projects from the widthwise middle portion of an upper peripheral wall 141a of the annular peripheral wall 141 to the rear side (or to the outside of the motor vehicle). The lower wall 142 projects from the widthwise middle portion of a lower peripheral wall (not illustrated) of the annular peripheral wall 141 to the rear side (or to the outside of the motor vehicle).

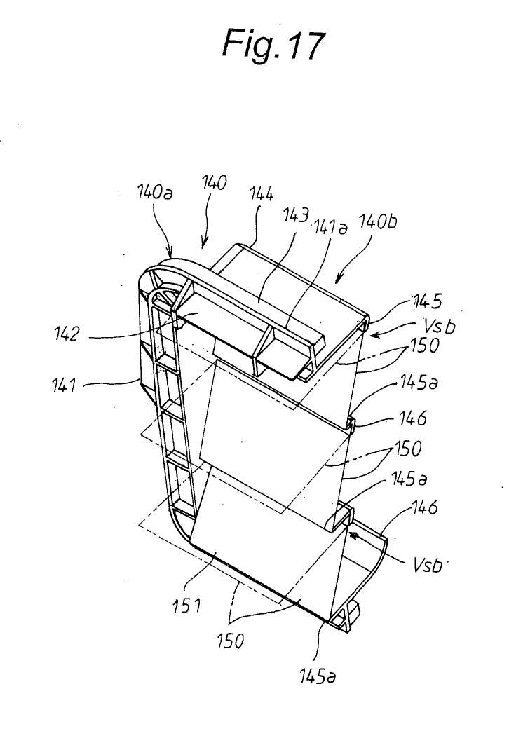

As illustrated in FIG. 17, the annular flange 143 projects from the width direction intermediate portion of the annular peripheral wall 141 to the front side (or to the inside of the motor vehicle). With this, the annular peripheral wall 141 can be uniformly contacted, at the outer periphery of the width direction intermediate portion (hereinafter, also called an annular contacting portion 141a), into an opening portion 121d (see FIG. 15) formed in the rear plate 121c of the left outer plate 121 of the vehicle body 120, from the rear side (or from the outside of the motor vehicle).

In the mounting frame 140a of the left valve seat member 140, the annular flange 143 is inserted from the rear side (or from the outside of the motor vehicle) into the opening portion 121d of the rear plate 121c of the left outer plate 121, and the annular peripheral wall 141 is uniformly contacted, at the annular contacting portion 141a, onto the outer peripheral end portion of the opening portion 121d of the rear plate 121c from the rear side (or from the outside of the motor vehicle). Thus, the mounting frame 140a is mounted in the opening portion 121d of the rear plate 121c.

As seen from FIG. 17, the valve seat portion body 140b has an annular peripheral wall 144, and a front wall 145. The annular peripheral wall 144 extends from the inner peripheral end portion of the annular peripheral wall 141 of the mounting frame 140a to the front side (or to the inside of the motor vehicle).

The front wall 145 forms the valve seat portion body 140b in a U-shaped longitudinal cross section together with the annular peripheral wall 141 so as to close opening portions on the extending end side of the annular peripheral wall 141 (see FIG. 17). The front wall 145 has three opening portions 145a (see FIG. 17). The opening portions 145a are formed by cutting away the upper, middle, and lower portions of the front wall 145, in a rectangular shape. In this embodiment, from the upper side, the three opening portions 145a are, hereinafter, also called an upper opening portion 145a, a middle opening portion 145a, and a lower opening portion 145a.

The valve seat portion body 140b has three seating walls 146 (FIG. 17). From the upper side in FIG. 17, the seating walls 146 are, hereinafter, also called an upper seating wall 146, a middle seating wall 146, and a lower seating wall 146.

The upper seating wall 146 extends, in a U shape, from the inner peripheral end portion of the upper opening portion 145a to the rear side (or to the outside of the motor vehicle). The upper seating wall 146 has an extending end formed from the upper end portion to the lower end portion of the inner peripheral end portion of the upper opening portion 145a, and is inclined to the rear side. Thereby, the upper seating wall 146 forms, at the extending end thereof, an annular valve seat portion (hereinafter, an upper valve seat portion) for seating the upper plate-shaped valve element 150 together with the upper end portion of the inner peripheral end portion of the upper opening portion 145a.

The middle seating wall 146 extends, in a U shape, from the inner peripheral end portion of the middle opening portion 145a to the rear side (or to the outside of the motor vehicle). The middle seating wall 146 has an extending end formed from the upper end portion to the lower end portion of the inner peripheral end of the middle opening portion 145a, and is inclined to the rear side. Thus, the middle seating wall 146 forms, at the extending end thereof, an annular valve seat portion (hereinafter, a middle valve seat portion) for seating the middle plate-shaped valve element 150 together with the upper end portion of the inner peripheral end of the middle opening portion 145a.

The lower seating wall 146 extends, in a U shape, from the inner peripheral end portion of the lower opening portion 145a to the rear side (or to the outside of the motor vehicle). The lower seating wall 146 has an extending end formed from the upper end portion to the lower end of the inner peripheral end portion of the lower opening portion 145a, and is inclined to the rear side. Thus, the lower seating wall 146 forms, at the extending end thereof, an annular valve seat portion (hereinafter, a lower valve seat portion) for seating the lower plate-shaped valve element 150 together with the upper end portion of the inner peripheral end portion of the lower opening portion 145a.

The three plate-shaped valve elements 150 each have a valve element body 151, and a plurality of connection portions (not illustrated) projecting upward from the upper end portion of the valve element body 151 and spaced from each other, and are integrally made of rubber.

The left upper plate-shaped valve element 150 is supported, at the plurality of connection portions, on the upper end portion of the inner peripheral end portion of the upper opening portion 145a, and is swingable in a longitudinal direction. The upper valve seat portion is formed from the upper end portion of the inner peripheral end portion of the upper opening portion 145a to the lower end portion of the upper seating wall 146, and is inclined to the rear side. Under its own weight, the left upper plate-shaped valve element 150 is seated on the upper valve seat portion from the rear side, thereby closing the upper valve seat portion.

The left middle plate-shaped valve element 150 is supported, at the plurality of connection portions, on the upper end portion of the inner peripheral end portion of the middle opening portion 145a, and is swingable in the longitudinal direction. The middle valve seat portion is formed from the upper end portion of the inner peripheral end portion of the middle opening portion 145a to the lower end portion of the middle seating wall 146, and is inclined to the rear side. Under its own weight, the left middle plate-shaped valve element 150 is seated on the middle valve seat portion from the rear side, thereby closing the middle valve seat portion.

The left lower plate-shaped valve element 150 is supported, at the plurality of connection portions, on the upper end portion of the inner peripheral end portion of the lower opening portion 145a, and is swingable in the longitudinal direction. The lower valve seat portion is formed from the upper end portion of the inner peripheral end portion of the lower opening portion 145a to the lower end portion of the lower seating wall 146, and is inclined to the rear side. Under its own weight, the left lower plate-shaped valve element 150 is seated on the lower valve seat portion from the rear side, thereby closing the lower valve seat portion.

The left upper plate-shaped valve element 150 constructed as above is seated, at the valve element body 151, on the upper valve seat portion from the rear side (or from the outside of the motor vehicle), thereby closing the upper opening portion 145a via the upper seating wall 146. This inhibits air inside the vehicle body 120 (or inside the motor vehicle) from being exhausted from the vehicle body 120 (or the motor vehicle). In this embodiment, each plate-shaped valve element 150 is also called a shield plate, and does not exhibit sound absorption ability.

The left upper plate-shaped valve element 150 is separated, at the valve element body 151, from the upper valve seat portion to the rear side, thereby opening portion the upper opening portion 145a via the upper seating wall 146. This exhausts an air stream inside the motor vehicle from the motor vehicle.

The left middle plate-shaped valve element 150 constructed as above is seated, at the valve element body 151, on the middle valve seat portion from the rear side (or from the outside of the motor vehicle), thereby closing the middle opening portion 145a via the middle seating wall 146. This inhibits air inside the vehicle body 120 (or inside the motor vehicle) from being exhausted from the vehicle body 120 (or the motor vehicle).

The left middle plate-shaped valve element 150 is separated, at the valve element body 151, from the middle valve seat portion, to the rear side, thereby opening the middle opening portion 145a via the middle seating wall 146. This exhausts an air stream from the inside of the motor vehicle, to the outside of the motor vehicle.

The left lower plate-shaped valve element 150 constructed as above is seated, at the valve element body 151, on the lower valve seat portion from the rear side (or from the outside of the motor vehicle), thereby closing the lower opening portion 145a via the lower seating wall 146. This inhibits air inside the vehicle body 120 (or inside the motor vehicle) from being exhausted from the vehicle body 120 (or the motor vehicle).

The left lower plate-shaped valve element 150 is separated, at the valve element body 151, from the lower valve seat portion to the rear side, thereby opening the lower opening portion 145a via the lower seating wall 146. This exhausts an air stream inside the motor vehicle from the motor vehicle.

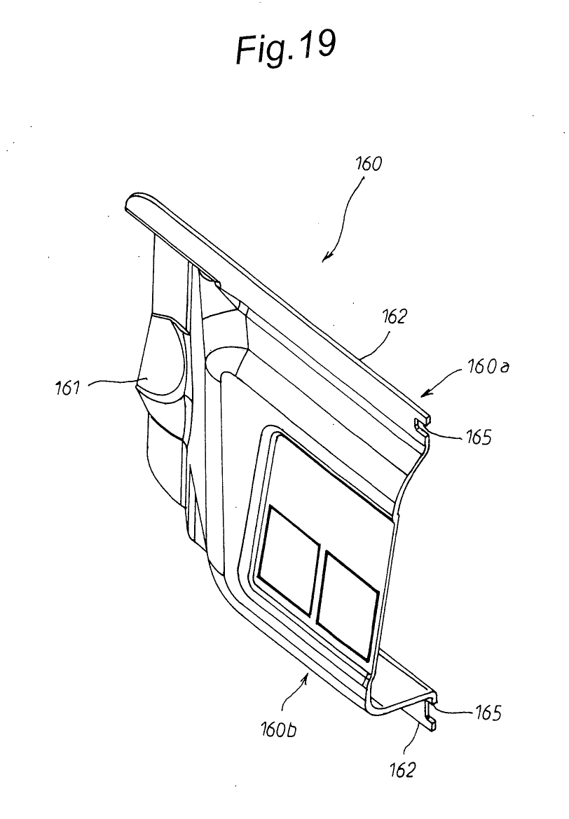

As illustrated in FIGS. 18 and 19, the left cover member 160 has an annular peripheral wall 160a, and a sound absorption cover 160b. The left cover member 160 is integrally made of the fiber sound absorption material described in the first embodiment. The annular peripheral wall 160a and the sound absorption cover 160b are, hereinafter, also called a left annular peripheral wall 160a and a left sound absorption cover 160b, respectively.

As illustrated in FIG. 18 or 19, the left annular peripheral wall 160a is formed annularly by sleeve-shaped left and right walls 161 and belt-shaped upper and lower walls 162. The sleeve-shaped left wall 161 extends in a sleeve shape from the left end portion of the left sound absorption cover 160b to the left side. The sleeve-shaped right wall 161 inclinedly extends in a sleeve shape from the right end portion of the sound absorption cover 160b, and is bent in the right inner face direction thereof (or in the right front direction) (see FIG. 18).

The left sound absorption cover 160b integrally bulges in a curved shape of lateral cross section from the inner peripheral end portion of the annular peripheral wall 160a to the rear side. The sound absorption cover 160b has a peripheral wall 163, and a center wall 164. The peripheral wall 163 extends integrally from the inner peripheral end portion of the annular peripheral wall 160a to the rear side. The center wall 164 is integrally formed, at the outer peripheral end portion thereof, with the extending end of the peripheral wall 163, and forms the sound absorption cover 160b in a curved shape of U-shaped cross section together with the peripheral wall 163.

As seen from FIG. 18, the sleeve-shaped right wall 161 of the annular peripheral wall 160a is integrally formed, at the extending base end intermediate portion thereof, with the extending direction intermediate portion of a right wall 163a of the peripheral wall 163.

The left cover member 160 constructed in this manner is mounted on the rear plate 121c of the left outer plate 121 of the vehicle body 120, between the rear bumper 130 and the left rear corner of the vehicle body 120, as follows.

The left cover member 160 is contacted, at the walls of the left cover member 160 except for the sleeve-shaped right wall 161 of the annular peripheral wall 160a, that is, the sleeve-shaped left wall 161 and the belt-shaped upper and lower walls 162 onto the outer peripheral end portion of the opening portion 121d of the rear plate 121c of the left outer plate 121 from the rear side (or from the outside of the motor vehicle) (see FIG. 15). With this, the center wall 164 is opposite to the opening portion 121d, and faces the hollow portion of the mounting frame 140a of the left valve seat member 140 through the opening portion 121d. The upper and lower walls 142 of the mounting frame 140a extend into the left sound absorption cover 160b along the upper and lower inner peripheral end portions of the opening portion 121d.

The annular peripheral wall 160a extends, at the sleeve-shaped right wall 161, along the rear portion on the right side of the vehicle body 120 (see FIG. 15). The sleeve-shaped right wall 161 extends to the rear side of the left rear corner of the vehicle body 120 so as to be away from the rear outer face of the left rear corner of the vehicle body 120.

The sleeve-shaped right wall 161 of the left cover member 160 serves as a releasing portion which forms a communication passage R (see FIG. 15) communicating the inside of the left sound absorption cover 160b, with the outside, between the sleeve-shaped right wall 161 and the outer face of the left rear corner of the vehicle body 120.

In this embodiment, in the left cover member 160, the annular peripheral wall 160a is mounted on the annular peripheral wall 141 of the mounting frame 140a of the left valve seat member 140, through a plurality of through holes (not illustrated) disposed in the rear plate 121c of the left outer plate 121, by means of a plurality of hook members (not illustrated). The hook members are connected to the annular peripheral wall 141 of the mounting frame 140a through the through holes 165 (FIG. 18 illustrates only one through hole 165) of the annular peripheral wall 160a and through holes (not illustrated) disposed in the rear plate 121c of the left outer plate 121.

The right air exhaust valve Vb is equal in construction to the left air exhaust valve Vb. The right air exhaust valve Vb has the valve body Bb and the cover member 160 which are equal in construction to the valve body Bb and the cover member 160 of the left air exhaust valve Vb. The valve body B of the right air exhaust valve Vb has the valve seat member 140 and the three plate-shaped valve elements 150 which are equal in construction to the valve seat member 140 and the three plate-shaped valve elements 150 of the valve body B of the left air exhaust valve Va.

At mounting the rear bumper 130 on the rear portion of the vehicle body 120, each of the left and right air exhaust valves Vb is mounted on the rear portion on each of the left and right sides of the vehicle body 120, as described above. Then, the rear bumper 130 is mounted on the rear portion on each of the left and right sides of the vehicle body 120, via each of the left and right cover members 160, along the direction indicated by the arrow of the alternate long and two short dashes line, as illustrated in FIG. 15.

In the fourth embodiment thus constructed, when each of the left and right air exhaust valves Vb is mounted on the rear portion on each of the left and right sides of the vehicle body 120 of the motor vehicle (see FIG. 15), as described above, in the left air exhaust valve Vb, the left valve body Bb and the left cover member 160 are mounted mutually via the rear plate 121c of the left outer plate 121 of the vehicle body 120 (see FIG. 15), as follows.

In the left air exhaust valve Vb, the valve seat member 140 is contacted, at the mounting frame 140a, onto the outer peripheral end portion of the opening portion 121d (see FIG. 15) of the rear plate 121c of the left outer plate 121, from the left inner plate 122 side of the vehicle body 120. The left cover member 160 is contacted, at the portion of the annular peripheral wall 160a except for the sleeve-shaped right wall 161, onto the outer peripheral end portion of the opening portion 121d of the rear plate 121c from the left portion 132 side of the rear bumper 130.

The upper and lower walls 142 of the valve seat member 140 extend into the sound absorption cover 160b along the upper and lower inner peripheral end portions of the opening portion 121d.

The left annular peripheral wall 160a is mounted on the annular peripheral wall 141 of the mounting frame 140a of the left valve seat member 140, through the plurality of through holes of the rear plate 121c of the left outer plate 121, by means of the plurality of hook members.

Thereby, the left valve body Bb and the left cover member 160 are mounted mutually in air-tight and liquid-tight manner via the rear plate 121c of the left outer plate 121 of the vehicle body 120.

In the substantially same manner as the left air exhaust valve Vb, in the right air exhaust valve Vb, the right valve body Bb and the right cover member 160 are mounted mutually in air-tight and liquid-tight manner via the rear plate 121c of the right outer plate 121 of the vehicle body 120. Each plate-shaped valve element 150 of the valve body Bb of the right air exhaust valve Vb is opposite to the rear portion of the right inner plate 122.

In such amounted state, in the left air exhaust valve Vb, each plate-shaped valve element 150 is opposite to the rear portion of the left inner plate 122, and the left cover member 160 extends, at the sleeve-shaped right wall 161 of the annular peripheral wall 160a, to the rear side via the left rear corner of the vehicle body 120.

Thus, in left air exhaust valve Vb, the valve seat member 140 is released, at the hollow portion of the mounting frame 140a, to the rear side of the vehicle body 120 through the releasing portion as the sleeve-shaped right wall 161 of the annular peripheral wall 160a. In other words, the hollow portion of the mounting frame 140a is released through the rear plate 121c of the left outer plate 121 of the vehicle body 120 and the communication passage R between the rear portion on the left side of the vehicle body 120 and the sleeve-shaped right wall 161 of the annular peripheral wall 160a of the left cover member 160 to the rear side of the vehicle body 120. Each plate-shaped valve element 150 closes each opening portion 145a of the valve seat portion body 140b under its own weight.

In the right air exhaust valve Vb, each plate-shaped valve element 150 is opposite to the rear portion of the right inner plate 122, and the right cover member 160 extends, at the sleeve-shaped right wall 161 of the annular peripheral wall 160a, to the rear side via the right rear corner of the vehicle body 120.

Thus, in the right air exhaust valve Vb, the valve seat member 140 is released, at the hollow portion of the mounting frame 140a, to the rear side of the vehicle body 120 through the releasing portion as the sleeve-shaped right wall 161 of the annular peripheral wall 160a. In other words, the hollow portion of the mounting frame 140a is released to the rear side of the vehicle body 120 through the rear plate 121c of the right outer plate 121 of the vehicle body 120 and the communication passage R between the rear portion on the right side of the vehicle body 120 and the sleeve-shaped right wall 161 of the annular peripheral wall 160a of the right cover member 160. Each plate-shaped valve element 150 of the right air exhaust valve Vb closes each opening portion 145a of the valve seat portion body 140b under its own weight (see each solid line in FIG. 16).

This means that each of the left and right air exhaust valves Vb shields, at the valve portion thereof, the space passage communicating with the inside of the vehicle compartment of the vehicle body 120, between the outer plate 121 and the inner plate 122 of the vehicle body 120 of the motor vehicle from the outside of the vehicle body 120.

Each of the left and right cover members 160 is opposite, at the inner face side thereof, to each of the left and right portions 132 of the rear bumper 130. Thus, each of left and right air exhaust valves Vb is not seen from the outside of the motor vehicle. Each of the left and right exhaust valves Vb does not deteriorate the appearance of the motor vehicle.

Like the first embodiment, when the motor vehicle on which the left and right air exhaust valves Vb are mounted is driven and is then stopped, and the passenger opens the door of the vehicle body 10 of the motor vehicle, gets off, and closes the door, air inside the vehicle compartment of the vehicle body 10 causes pressure (air pressure) in the inside of the vehicle body 10, with the closing of the door, as described above.

The air which causes the air pressure is pushed out, as an air stream, into the space passage of the vehicle body 120, with the closing of the door, and flows toward each of the left and right air exhaust valves Vb.

Then, the air stream flows toward the plate-shaped valve elements 150 of each of the left and right air exhaust valves Vb, and pushes the plate-shaped valve elements 150 to the rear side (or to the outside of the motor vehicle). With this, the plate-shaped valve elements 150 swing to the sound absorption cover 160b side of each of the left and right cover members 160, thereby opening the opening portions 145a of each valve seat portion body 140b. This means that the valve portion of each of the left and right air exhaust valves Vb is opened.

Thus, the air stream which flows through the valve portion of each of the left and right exhaust valves Vb flows along the airflow passage into the sound absorption cover 160b of each of the left and right cover members 160 through the opening portion 121d of each of the left and right outer plates 121.

The air stream which flows into each sound absorption cover 160b is exhausted through each of the left and right communication passages R to the rear side of the vehicle body 120. This means that the air stream from the inside of the vehicle compartment of the vehicle body 120 is exhausted to the rear side of the motor vehicle by each of the left and right exhaust valves Vb.

In this case, as described above, the air stream from the inside of the vehicle compartment of the vehicle body 120 is exhausted to the rear side of the motor vehicle, not to each of the left and right sides of the motor vehicle. Thus, the operation and effect of the first embodiment is further improved.

When each of the left and right exhaust valves Vb exhausts the air stream from the inside of the vehicle compartment of the vehicle body 120 to the rear side of the motor vehicle, as described above, the plate-shaped valve elements 150 of each of the left and right air exhaust valves Vb swing to each of the left and right portions 132 of the rear bumper 130, and opens the opening portions 145a of each valve seat portion body 140b.

In such a state, noises from the outside of the vehicle body 120 (or from the outside of the motor vehicle) (e.g., noise such as road noises, from each of the left and right rear wheels RL, RR) enter into each communication passage R, from between the sleeve-shaped right wall 161 of the annular peripheral wall 160a of each of the left and right cover members 160 and each of the left and right rear portions of the vehicle body 120. This means that the noise such as road noises, enter into a right sleeve 170 and the sound absorption cover 160b of each of the left and right cover members 160.

As described above, each of the left and right cover members 160 is made of the fiber sound absorption material. Each sound absorption cover 160b is formed in a curved shape of convex cross section toward the outside. Thus, the noises such as road noises, which pass through each communication passage R is absorbed by the sleeve-shaped right wall 161 of the annular peripheral wall 160a of each cover member 160, and is absorbed favorably by the sound absorption cover 160b.

The sleeve-shaped right wall 161 of the annular peripheral wall 160a of each of the left and right cover members 160 is farther from each of the left and right rear wheels RL, RR of the motor vehicle, than each of the left and right air exhaust valves V described in the first embodiment. Thus, the noises such as road noises, which enter into each of the left and right air exhaust valves Vb is attenuated more favorably in each of the left and right air exhaust valves Vb than in each of the left and right air exhaust valves V in the first embodiment.

Thus, the noises which enter into each cover member 160 is absorbed and attenuated favorably by the sleeve-shaped right wall 161 of each annular peripheral wall 160a and each sound absorption cover 160b, as described above. This means that the cover member 160 having the above construction exhibits considerably favorable sound absorption ability, that is, sound reduction ability, with regard to the noises which enter into the inside thereof.

As a result, the noises from the outside of the motor vehicle hardly enter through the opening portion 121d of each of the left and right outer plates 121 and each valve body Bb, into the space passage between the outer plate 121 and the inner plate 122 of the vehicle body 120. This means that, when each of the left and right air exhaust valves Vb exhausts the air stream from the inside of the vehicle body 120 to the outside of the motor vehicle, the intrusion of the noises from the outside of the motor vehicle into the inside of the vehicle compartment of the vehicle body 120 are shielded favorably by each of the left and right air exhaust valves Vb.

As described above, even when air inside the vehicle body 120 causes pressure in the inside of the vehicle body 120 at closing the door, the air having the pressure is exhausted, as an air stream, favorably at good timing, to the rear side of the motor vehicle by each of the left and right air exhaust valves Vb, as described above, so that the door can be easily closed. Besides, each cover member 160 having the above construction is disposed to each of the left and right air exhaust valves Vb, so that, when each of the left and right air exhaust valves Vb exhausts the air stream, noises which enter from the outside of the motor vehicle into each of the left and right air exhaust valves Vb is absorbed and attenuated favorably by the cover member 160 of each of the left and right air exhaust valves Vb. As a result, the passenger in the vehicle compartment is not given an uncomfortable feeling from noises which are likely to enter through at least one of the left and right air exhaust valves Vb into the vehicle compartment.

The sound transmission ability of the right air exhaust valve Vb of the left and right air exhaust valves Vb in the fourth embodiment was compared with the sound transmission ability of the right air exhaust valve V described in the first embodiment, by a sound transmission measuring method, in accordance with the relation between the sound transmission loss and the frequencies. The window side and the inside of the rear seat on the driver's seat side of the motor vehicle were measuring positions.

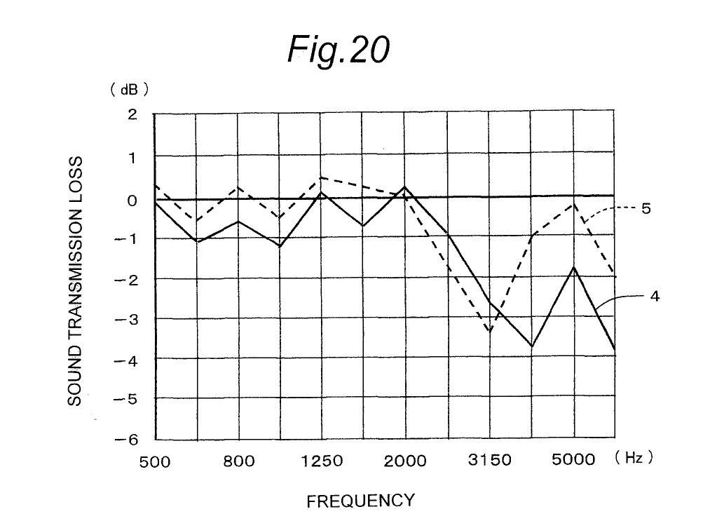

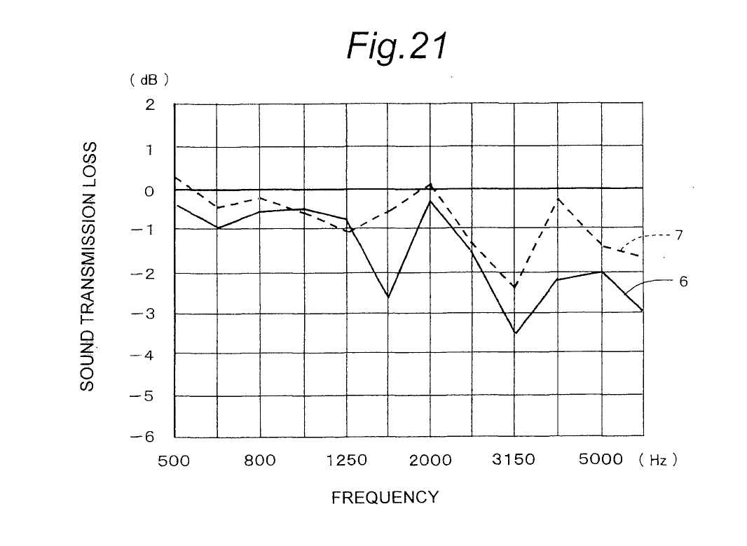

From this, graphs 4 to 7 illustrated in FIGS. 20 and 21 were obtained. Graphs 4, 5 in FIG. 20 show the measured results on the window side of the rear seat on the driver's seat side of the motor vehicle. Graph 4 shows the sound transmission characteristic of the right air exhaust valve Vb. Graph 5 shows the sound transmission characteristic of the right air exhaust valve V.

Graphs 6, 7 in FIG. 21 show the measured results on the inside of the rear seat on the driver's seat side of the motor vehicle. Graph 6 shows the sound transmission characteristic of the right air exhaust valve Vb. Graph 7 shows the sound transmission characteristic of the right air exhaust valve V.

From both the graphs in FIG. 20, the sound transmission characteristic of the right air exhaust valve Vb is more favorable than the sound transmission characteristic of the right air exhaust valve V. In other words, the sound shield effect of the right air exhaust valve Vb is more favorable than the sound shield effect of the right air exhaust valve V.

From both the graphs in FIG. 21, the sound transmission characteristic of the right air exhaust valve Vb is more substantially favorable than the sound transmission characteristic of the right air exhaust valve V. In other words, the sound shield effect of the right air exhaust valve Vb is more substantially favorable than the sound shield effect of the right air exhaust valve V.

In embodying the present invention, the following various modifications are given without being limited to the above embodiments.

(1) In embodying the present invention, the gasket 80 is not required to be grasped as the component member of the air exhaust valve V or Va.

(2) In embodying the present invention, the partition mechanism described in the first or third embodiment has any construction as long as it has the ventilation holes. In addition, the partition mechanism may be eliminated since the valve seat member has the annular valve seat portion.

(3) In embodying the present invention, in the first embodiment, the opening portion 64a of the sound absorption cover 60b is formed in the position except for the passage in which noises which enter from the outside of the motor vehicle through the annular valve seat portion of the valve seat member 40 into the sound absorption cover 60b is incident so as to collide with the wall of the sound absorption cover 60b, and is not required to be positioned in the lower wall 64.

(4) In embodying the present invention, in the first embodiment, when, at mounting air exhaust valve V into the mounting bore 11a of the vehicle body 10, the valve seat portion wall 41 of the valve seat member 40 is mounted into the mounting bore 11a, via the annular peripheral wall 60a of the cover member 60 and the gasket 80, from the outside of the motor vehicle, the mounting member 70 may be eliminated.

(5) In embodying the present invention, the air exhaust valve described in the first or third embodiment may be mounted on the rear portion on the left or right side of the vehicle body 10. In addition, when the rear bumper 30 is integral with the rear portion of the vehicle body 10, the air exhaust valve may be mounted on the rear portion of the vehicle body 10, from the lower side thereof. In the mounting, in either case, the air exhaust valve communicates into the space passage.

(6) In embodying the present invention, the cover members 100, 110 described in the third embodiment may have one annular wall. In this case, the sound absorption cover 110b of the cover member 110 extends, in a U-shaped cross section, from the annular wall of the cover member 100, to the front side.

(7) In embodying the present invention, the cover members 100, 110 described in the third embodiment may be formed of the three-layer structure equal to that of the cover member 60 described in the second embodiment. This can synergistically achieve the operations and effects of the second and third embodiments.

(8) In embodying the present invention, in the cover member 60A described in the second embodiment, the material for the barrier film 65b is not limited to nylon, and may be a resin such as a polyester film. In addition, the material for the fusion films 65a, 65c is a thermoplastic resin which is lower melting point than the material for the barrier film (or a melting point of 200 (° C.) or less), e.g., polyethylene, polypropylene, polyethylene terephthalate, and unsaturated polyester.

(9) In embodying the present invention, the cover member and the sound absorption cover in the first and third embodiments may be grasped as a sound reduction member and a sound reduction cover, respectively, by grasping sound absorption as the subordinate concept of sound reduction. In addition, the cover member and the sound absorption and shield cover in the second embodiment may be grasped as a sound reduction member and a sound reduction cover, respectively, by grasping both of sound absorption and sound shield as the subordinate concept of sound reduction.

(10) In embodying the present invention, the air exhaust valve described in each of the embodiments may be subjected to a water repelling process, from the plate-shaped valve element side. This can prevent water from the outside of the vehicle body, such as splashed water from a driving road surface, from intruding into the inside of the air exhaust valve.

(11) In embodying the present invention, each of the embodiments is not limited to one cover member or two cover members, and the cover member may be a cover body having a sound absorption cover in a U-shaped cross section.

(12) In embodying the present invention, the cover member 160 described in the fourth embodiment is not limited to having one layer, and may have the three-layer structure described in the second embodiment.

(13) The present invention is not limited to the motor vehicle, and may be applicable to a motor vehicle including a bus, a truck, and the like.

1-11. (canceled)

12. A motor vehicle provided with a vehicle body having an outer plate and an inner plate located inside of the outer plate to form therein a vehicle compartment and with a rear bumper supported by the outer plate so as to be spaced therefrom and comprising an air exhaust valve mounted on a side rear portion of the outer plate, wherein said air exhaust valve comprises:
a valve body including an annular valve seat portion and a plate-shaped valve element extending downward from an upper end portion of the annular valve seat portion, the plate-shaped valve element being opened by receiving an air stream flowing toward the annular valve seat portion, and
a cover body disposed to face said valve body so as to form an airflow passage therein in between said valve body, thereby to exhaust the air stream to the outside through the airflow passage,
wherein said cover body is formed from a sound reduction material so as to reduce noises which enter from the outside of the rear portion of the vehicle body into said cover body, and
wherein said air exhaust valve is mounted on the side rear portion of the outer plate so as to be spaced from an opposite portion of the rear bumper to the side rear portion of said outer plate toward the side rear portion of the outer plate.

13. The motor vehicle according to claim 12, wherein said air exhaust valve includes a valve seat member forming the annular valve seat portion,
wherein the plate-shaped valve element is supported on said valve seat member in such a manner that it extends downward from the upper end portion of the annular valve seat portion of said valve seat member so as to open and close the annular valve seat portion to and from one side of both sides of said valve seat member,
said cover body is integrally formed with the sound reduction material so as to have an annular peripheral wall mounted on the outer peripheral portion of said valve seat member from the other side of the both sides of said valve seat member, and a sound reduction cover mounted on the annular peripheral wall so as to oppose the annular valve seat portion from the other side of said valve seat member in the form of a curved shape of convex cross section toward the other side of said valve seat member,
wherein an opening portion is formed corresponding to the inner end portion of the airflow passage at a portion out of a facing portion of said sound reduction cover to the annular valve seat portion, and
wherein said air exhaust valve is positioned at its the plate-shaped valve element toward the outside of the vehicle body, thereby to communicate at the opening portion of said sound reduction cover into the interior of the vehicle body.

14. The motor vehicle according to claim 13, wherein said sound reduction cover bulges from the inner peripheral end portion of the annular peripheral wall toward the other side of said valve seat member in the form of a curved shape of convex cross section so as to oppose the annular valve seat portion, said sound reduction cover forming at a lower wall portion thereof a lower opening portion as the opening portion.

15. The motor vehicle according to claim 12,
wherein the air exhaust valve further comprises:
a valve seat member forming the annular valve seat portion,
wherein the plate-shaped valve element is supported on said valve seat member in such a manner that it extends downward from the upper end portion of the annular valve seat portion of said valve seat member so as to open and close the annular valve seat portion to and from one side of both sides of said valve seat member,
wherein said cover body includes first and second sound reduction cover members,
wherein said first sound reduction cover member has an annular peripheral wall mounted on the outer periphery of said valve seat member from the other side of the both sides of said valve seat member, and a sound reduction cover bulged from the inner peripheral end portion of the annular peripheral wall to the other side of said valve seat member in the form of a curved shape of convex cross section so as to cover the annular valve seat portion, said sound reduction cover forming a first opening portion at its opposing wall portion to said valve seat member,
said second sound reduction cover member has an annular peripheral wall mounted on the annular peripheral wall of said first sound reduction cover member from the other side of said valve seat member, and a sound reduction cover bulged from the inner peripheral end portion of the annular peripheral wall to the other side of said valve seat member in the form of a curved shape of convex cross section so as to cover said first sound reduction cover member, and
wherein a second opening portion is formed in the opposing wall portion of said sound reduction cover of said second sound reduction cover member to said valve seat member so as to be located in a position off the first opening portion correspondingly to the inner end portion of the airflow passage together with the first opening portion.

16. The motor vehicle according to claim 13, wherein the sound reduction cover is a sound absorption and insulation cover which includes a barrier film made of a thermoplastic resin material and first and second films made respectively of a thermoplastic material which is lower in melting point than the thermoplastic resin material, said sound absorption and insulation cover being formed as a three-layer structure in which the first and second films are fused to the barrier film from both sides of the barrier film.

17. The motor vehicle according to claim 15, wherein each of sound reduction covers of said first and second sound reduction cover members is a sound absorption and insulation cover which includes a barrier film made of a thermoplastic resin material and first and second films made respectively of a thermoplastic material which is lower in melting point than the thermoplastic resin material, said sound absorption and insulation cover being formed as a three-layer structure in which the first and second films are fused to the barrier film from both sides of the barrier film.

18. A motor vehicle provided with a vehicle body having an outer plate and an inner plate located inside of the outer plate to form therein a vehicle compartment and with a rear bumper supported by a rear portion of the outer plate so as to be spaced therefrom and comprising an air exhaust valve mounted on the rear portion of the outer plate at its side portion,
wherein said air exhaust valve comprises:
a valve seat member including an annular valve seat portion and a plate-shaped valve element supported on said valve seat member in such a manner that it extends downward from the upper end portion of the annular valve seat portion of said valve seat member so as to open and close the annular valve seat portion to and from one side of both sides of said valve seat member, and
a cover body integrally formed with a sound reduction material such that it has an annular peripheral wall disposed on the outer periphery of said valve seat member so as to correspond to said valve seat member from the one side of said valve seat member, and a sound reduction cover extending from the annular peripheral wall so as to oppose the annular valve seat portion from the one side of said valve seat member in the form of a curved shape of convex cross section toward the one side of said valve seat member, the annular peripheral wall being extended at its one portion in the form of a sleeve-like shape as a releasing portion for releasing the inside of the sound reduction cover to the outside,
wherein the valve body is located at its plate-shaped valve element so as to oppose an opposite portion of the rear bumper to the side rear portion of the outer plate, and
wherein said air exhaust valve is mounted on the side rear portion of the outer plate so as to be spaced from an opposite portion of the rear bumper to the side rear portion of the outer plate toward the side rear portion of the outer plate.
